(19) United States
(12) Patent Application Publication
(10) Pub. No.: US 2018/0189886 A1
(43) Pub. Date: Jul. 5, 2018

(54) SYNTHETICALLY DENOMINATED DEBT INSTRUMENTS AND SYSTEMS AND METHODS THEREFOR

(71) Applicants: Renan C. PAGLIN, Brooklyn, NY (US); Smetrix Fixed Income Partners, Inc., Makati City (PH)

(72) Inventor: Renan C. PAGLIN, Brooklyn, NY (US)

(21) Appl. No.: 15/739,591

(22) PCT Filed: Jun. 22, 2016
(86) PCT No.: PCT/US16/38754

§ 371 Date: Dec. 22, 2017

Related U.S. Application Data
(60) Provisional application No. 62/183,704, filed on Jun. 23, 2015.

(51) Int. Cl. G06Q 40/06; G06Q 40/04; G06Q 40/02

(52) U.S. Cl. CPC G06Q 40/06; G06Q 40/02; G06Q 40/04

(57) ABSTRACT

Systems, methods, and computer program embodiments are disclosed for collateralizing and investing in synthetically denominated debt instruments. In an embodiment, a debt security is first issued in a first entity and denominated in a first currency local to the first entity. A currency swap on the debt security is issued, which specifies exchange of cash flows in the first currency for cash flows in a second currency local to the second entity. A synthetically denominated debt instrument is then created that is a combination of the debt security and the currency swap. In an embodiment, the synthetically denominated debt instrument is delivered to a depositary bank in the second entity. A depositary receipt representing the synthetically denominated debt instrument is issued in the second entity to an investor in the synthetically denominated debt instrument. Collateral assets are posted in the second entity and attached to the depositary receipt.

### BACKGROUND

### Field

Embodiments described herein are generally related to the fields of financial engineering, foreign exchange derivatives, structured products, international finance and cross-border investment, and to issuing, collateralizing and investing in synthetically denominated debt instruments.

### Background

The use of many national currencies outside the borders of the issuing countries are heavily restricted. A common restriction is a prohibition for non-residents from borrowing the currency or issuing debt instruments denominated in that currency. Although such a restriction may make monetary policy simpler to administer, it also limits the ability of that country's businesses from borrowing funds from foreign lenders without taking on foreign currency risk. Foreign currency risk exists when the borrower's revenues are denominated in a currency, usually the local currency, which is different from the currency required to repay the foreign borrowing.

Because of the prohibition from borrowing the local currency, foreign non-resident lenders cannot readily find a source for the country's currency and therefore cannot re-lend it to local businesses. Thus, many large local businesses that cannot find a sufficient number of domestic lenders who are willing to lend them local currency funds at affordable costs are forced to borrow foreign currency funds from foreign non-resident lenders. If such transactions occur in large numbers, this can complicate the administration of monetary policy because domestic money supply increases when borrowers exchange the proceeds of such foreign currency loans into the local currency.

### SUMMARY

Systems, methods, and computer program embodiments are disclosed for collateralizing and investing in synthetically denominated debt instruments. In an embodiment, a debt security is first issued in a first entity that is denominated in a first currency local to the first entity. A currency swap on the debt security is issued, which specifies exchange of cash flows in the first currency for cash flows in a second currency. The second currency may be a local currency of the second entity. A synthetically denominated debt instrument is then created. The synthetically denominated debt instrument is a combination of the debt security and the currency swap.

In an embodiment, the synthetically denominated debt instrument is delivered to a depositary bank in the second entity. A depositary receipt representing the synthetically denominated debt instrument is issued in the second entity by the depositary bank to an investor in the synthetically denominated debt instrument. Collateral assets are posted in the second entity and denominated in the second currency, and the collateral assets are attached to the depositary receipt such that the depositary receipt is exchangeable for the collateral assets in the event of non-payment of promised cash flows by the issuer of the debt security. In an embodiment, the collateral assets are held in a collateral account in the second entity by the depositary bank.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1A illustrates a base scenario in which problems of the prior art have been encountered.

FIG. 1B further illustrates a base scenario in which problems of the prior art have been encountered and a solution to these problems, according to an embodiment.

FIG. 2 illustrates a comparison of the prior art and embodiments disclosed herein.

FIG. 3 is an example system for collateralizing and investing in synthetically denominated debt instruments, according to an embodiment.

FIG. 4 is a diagram illustrating how synthetically denominated debt is created from the perspective of an issuer of an underlying debt instrument, according to an embodiment.

FIG. 5 is a diagram illustrating how synthetically denominated debt is created from the perspective of an investor, according to an embodiment.

FIG. 6 is a diagram illustrating investment in an investment instrument that allows the investor to participate in income from depositary receipts, according to an embodiment.

FIG. 7 is an example method for investing in an investment instrument that allows the investor to participate in income from depositary receipts, according to an embodiment, according to an embodiment.

FIG. 8 is a diagram illustrating investment in an investment instrument that allows the investor to participate in income earned from assets financed by the issuance or sale of a debt instrument which underlies a depositary receipt, according to an embodiment.

FIG. 9 is an example method for investing in an investment instrument that allows the investor to participate in income earned from assets financed by the issuance or sale of a debt instrument which underlies a depositary receipt, according to an embodiment, according to an embodiment.

FIG. 10 is an example method for investing in an investment instrument offered by the holder of one or more depositary receipts, according to an embodiment.

FIG. 11 is an example method for investing in an investment instrument offered by an issuer of a synthetically denominated debt instrument, according to an embodiment.

FIG. 12 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to include such feature, structure, or characteristic in connection with other embodiments whether or not explicitly described.

A common practice used by borrowers to protect themselves from foreign currency risk is for the borrower to enter into a foreign currency derivative contract such as cross-currency swap to convert its foreign currency liabilities into the local currency, thereby hedging the foreign currency risks. However, the cost of such a derivative instrument is often uneconomical for the borrower, if not impossible to obtain for the desired tenors, because of the cost of capital imposed on the borrower's counterparty due to the borrower's performance risk during the term of the derivative contract. This cost is likely to increase under the Basel III regulatory framework which requires banks, which act as dealers for such derivative contracts, to allocate more capital to such bilateral contracts.

A foreign non-resident lender which finances a borrower in another country has a specific kind of risk, often referred to as sovereign risk, which is not present when the lender and the borrower operate within the same country and transact in that country's local currency. In the context of cross-border lending, sovereign risk can be further divided and analyzed as two distinct but related types of risks: (a) the risk that the sovereign state where the borrower resides will prevent the borrower from transferring assets outside the country to repay its debt, which is referred to as transfer risk and (b) the risk that the sovereign state where the borrower resides will prevent the borrower from exchanging its local currency funds into foreign currency to repay the lender, which is referred to as convertibility risk. Sovereign states have the power to regulate the movement of assets into, out of, or within its territories and the unilateral exercise of this power gives rise to both transfer and convertibility risk.

The Articles of Agreement of the states which are members of the International Monetary Fund (IMF) also allow each of its member states to impose capital controls unilaterally under Article VI(3) which provides as follows:

“Members may exercise such controls as are necessary to regulate international capital movements, but no member may exercise these controls in a manner which will restrict payments for current transactions or which will unduly delay transfers of funds in settlement of commitments, except as provided in Article VII, Section 3(b) and in Article XIV, Section 2.”

Capital controls refer to restrictions imposed by a sovereign state restricting the movement of capital into or out of that country. These controls may include repayment of debt to a foreign lender.

Article VIII(2)(b) of the IMF Articles of Agreement also provides as follows:

“Exchange contracts which involve the currency of any member and which are contrary to the exchange control regulations of that member maintained or imposed consistently with this Agreement shall be unenforceable in the territories of any member. In addition, members may, by mutual accord, cooperate in measures for the purpose of making the exchange control regulations of either member more effective, provided that such measures and regulations are consistent with this Agreement.”

IMF Article VIII(2)(b) requires all member states to respect the foreign exchange controls that may be imposed by a member state by rendering contracts which conflict with those controls restrictions unenforceable in any state which is a member of the IMF. Since all of the world's financial centers are located in ⁻IMF member states, relying on foreign law or the foreign jurisdiction of an offshore financial center (i.e. offshore relative to the member state whose currency is the subject of the foreign exchange contract) to enforce and protect a foreign exchange contract against sovereign interference may well be futile exercise.

As a solution to the risk of sovereign interference adversely affecting foreign exchange contracts especially those involving the currencies of emerging market countries, financial markets have developed non-deliverable derivative instruments such as non-deliverable forwards (NDF). NDFs for emerging-market currencies do not involve the actual delivery or exchange of currencies. Instead of exchanging and delivering the actual currencies, the counterparties settle with each other by paying the difference by which the market price for the currencies has moved relative to the price agreed to at the inception of the NDF. The fixing date(s) of the NDF is the date at which the difference between the prevailing market exchange rate and the agreed-upon exchange rate is calculated. If there is a difference, then one party owes the other party a settlement payment which is the value of the difference denominated in a hard currency, usually the United States dollar. Since there is no actual delivery or exchange of physical currencies, the regulations of the foreign country which issues the underlying, referenced currency and IMF Article VIII(2)(b) do not cover such instruments.

A party who enters into an NDF contract and who desires to receive the actual currency needs to purchase the actual currency at the spot market at the time of settlement and use the payment under the NDF to offset the change in price, whether favorable or unfavorable, which has occurred since the inception of the NDF contract. In this way, that party has hedged the cost of acquiring the underlying physical currency. However, a risk for the party using the NDF is that when he needs to acquire the physical currency, there will be no spot market to obtain the currency because of exchange control regulations which may be imposed by the country's authorities. Even when the party is able to acquire the physical currency in the spot market, there is the risk that the fixing rate under the NDF contract is materially different from the actual exchange rate that can be achieved in the spot market at that time. This is because of basis risk which refers to the difference in quoted prices between various dealers or because of rigging risk. Rigging risk refers to the risk that the fixing rate will be manipulated by market dealers as alleged by regulators during the foreign exchange rigging scandals of 2012 which affected global markets.

A depositary receipt is a negotiable financial instrument issued by a bank, acting as a securities custodian, to represent a foreign company's publicly traded securities in this case foreign means foreign relative to the bank which issues the depositary receipt). The depositary receipt trades on a local securities exchange, usually a stock exchange because most depositary receipts are issued for shares of stock issued in foreign countries. Depositary receipts facilitates buying securities issued by foreign companies, because the underlying securities do not have to leave the home country.

A typical depositary receipt typically goes through the following process before it is issued: (1) The depositary bank which will issue the depositary receipt acting through its foreign branch or through an agent, such as a securities sub-custodian, buys the securities which are issued by the foreign company, (2) the underlying securities are grouped into packets, (3) each packet is issued as a depositary receipt after listing on a stock exchange, fixed income exchange or other alternative trading platform and (4) the depositary receipt is denominated and priced in the currency of the country where it is issued, and the dividends or interest coupons and principal repayment, if applicable, are paid out in that currency as well, making it as simple for a local investor to buy as a local security issued by a local company.

The issuer of the depositary receipt which is the depositary bank has the obligation to hold the underlying security in the territory where it was acquired. The issuer of the depositary receipt also has the obligation to convert the cash flows generated by the underlying security into the currency of a second country and transfer said currency to the holder of the depositary receipt located in that country.

The concept of a synthetic financial instrument is understood in the industry as creating the payoff or return of a specific kind of financial instrument by combining or using other financial instruments. For example, in the past, participants in the industry have combined a bond (or other kind of fixed income security) denominated in one currency with a cross-currency swap from another party in order to create the cash flow characteristics of a bond which is denominated in another currency, which is different from that of the bond. However, these two financial instruments—the bond and the currency swap—were always issued by different parties. No one has created a financial instrument that integrates a bond and currency swap issued by one and the same party to create a synthetically denominated bond, embodied in a single financial instrument. The prior art would consider the effort to create such an instrument as pointless because the issuer could simply issue the bond in the desired currency in a straightforward and conventional fashion, without resorting to the creation of two different instruments to create a synthetic structure that mimics the instrument that can be created in a conventional fashion. Unlike embodiments disclosed herein, the prior art did not understand the benefit of doing so.

In order to assure the performance by the issuer of a financial instrument, the prior art applies the abstract idea of collateralization, which is the idea whereby an issuer (or third party) pledges an asset as recourse for the other party to a contract in the event that the issuer defaults. The widespread and standard way that this abstract idea was applied in the prior art regarding currency swaps was to attach the collateral to the contract that needed to be secured, in this case, a currency swap which is a kind of foreign exchange derivative contract through the use of a Credit Support Annex integrated into a foreign exchange derivative contract. The prior art did not know where else to attach the collateral. The currency swap is an element of embodiments disclosed herein.

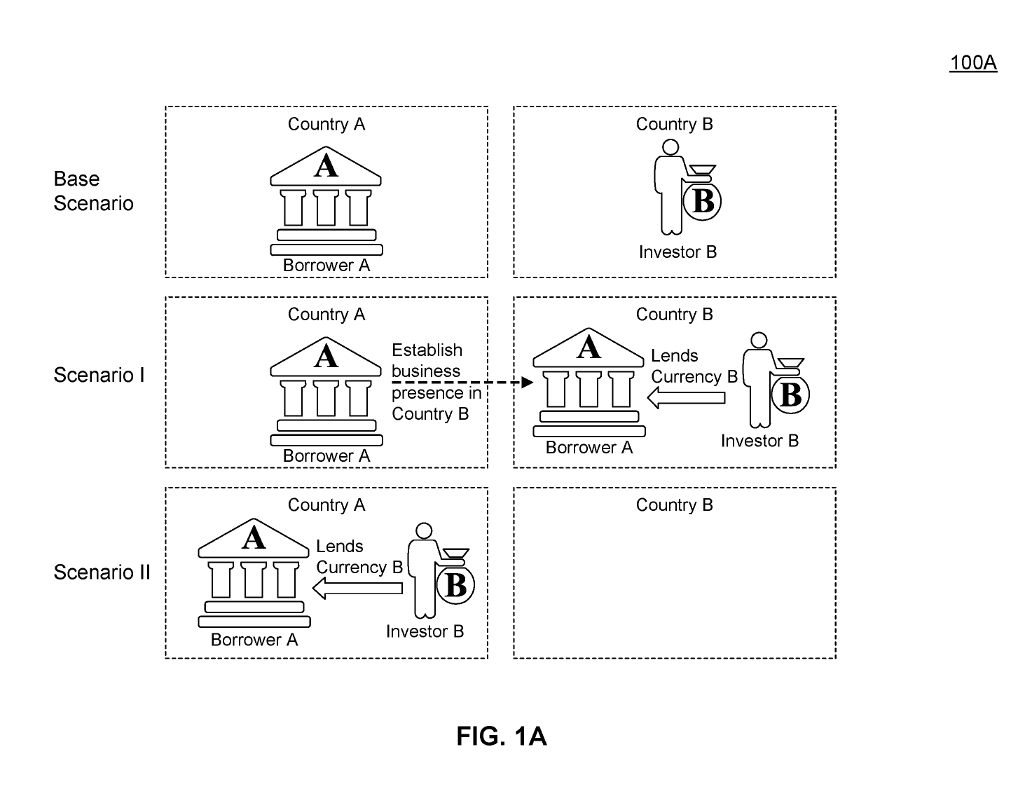

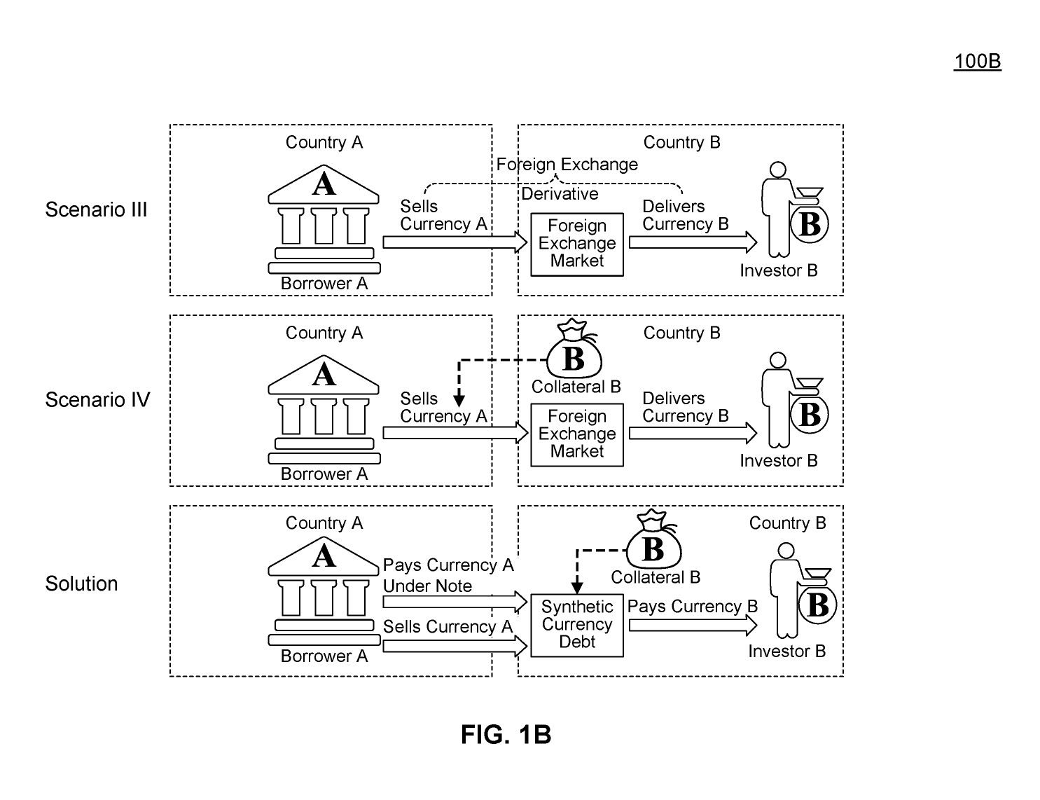

Scenarios I and II in FIG. 1A and scenarios III and IV in FIG. 1B provide a background of the inadequacies of cross-border debt financing as practiced in the past, as discussed further below.

Unlike the prior art, embodiments disclosed herein will effectively enable a bank or other financial institution which is operating in a first country (country A) while being unable to issue debt that is nominally denominated in the currency of a second country (country B) where it is not operating, to effectively borrow the currency of that second country (currency B) by issuing debt synthetically denominated in the currency of the second country (currency B) by having depositary receipts issued and sold to investors residing in country B. Embodiments disclosed herein also allow investors who reside in country B to purchase the synthetically denominated debt issued by the bank or other financial institution in country A while being protected against the risk that the exchange contract (i.e. currency swap) embedded in the depositary receipt, which is the enabling component of the synthetically denominated debt, will be rendered unenforceable by IMF Articles VI(3) and/or VIII(2)(b), thereby depriving the currency B cash flows expected by those depositary receipt investors. According to embodiments of the present inventions, the bank or financial institution in country A is able to effectively invest in long-term assets denominated in currency B without being exposed to currency risk as would be the case if it were to finance this investment with debt denominated in a different currency.

It is an object of one or more embodiments disclosed to synthetically denominate a debt instrument in the currency of country B, sell this debt instrument to a depositary bank which will then issue a depositary receipt to investors in country B so that the issuer of the debt instrument can use the currency B proceeds to invest in financial assets denominated in currency B, thereby avoiding currency mismatch risk between assets and liabilities.

It is another object of one or more embodiments disclosed to protect the investors in the depositary receipt from the risk of not receiving the return of their investment because the exchange contract (i.e. currency swap) which they are relying upon and which is embedded with the depositary receipt cannot be enforced because of the operation of international law (i.e. Article VIII(2)(b) of the Articles of Agreement of the International Monetary Fund with respect to the enforceability of exchange contracts).

Embodiments disclosed may involve the issuance by a bank or other financial institution of debt denominated in its country's currency. Investors from another country can buy this debt either (a) by opening a securities custody account within the territory of the country where the debt is issued or (b) by having a depositary bank purchase the debt in the country where the debt was issued and then purchasing depositary receipts issued by the depositary bank against the purchased debt.

Alternative (b) is advantageous and simpler for the investors because investors do not have to exchange their funds for transfer abroad, as they can readily purchase the depositary receipts in the local capital market. The depositary receipt can even be listed in a stock or fixed income exchange operating within the investors' country. When it comes time to liquidate their investment in depositary receipts, they can sell it to another investor within their home country, a feature which makes the depositary receipt a much more liquid and tradeable asset within their domestic capital market.

The problem with this arrangement as with all other financial arrangements involving depositary receipts is that the investors will be receiving payments in their local currency but which originally flowed from a foreign currency. The investors are therefore exposed to the risk that that foreign currency will depreciate during the term of their investment and as a result they will receive fewer local currency than expected. This risk is eliminated in embodiments disclosed herein by a currency swap which is bundled with the underlying debt and embedded with the depositary receipt. The issuer or seller of the debt instrument provides the currency swap for the benefit of the investors in the depositary receipt so that foreign currency cash flow arising from the debt instrument is swapped into local currency cash flow which is paid to the investors. Because the swap effectively converts the currency paid under the debt instrument underlying the depositary receipt at one or more predetermined exchange rates, the investors are left with a cash flow stream denominated in their own currency so that the cash flow is similar to that of a plain vanilla debt instrument such as a conventional local currency bond, which is denominated in the investors' local currency. The depositary receipt could then serve as a good substitute for conventional bonds which are issued and traded in the local capital market. A major benefit of the depositary receipts is the opportunity for credit diversification by allowing investors to access well-regarded foreign issuers without the currency risk that would be present if they directly invested in foreign currency bonds issued by those issuers.

Although combining the foreign currency bond with a currency swap nominally removes the currency risk, this does not mean that risk in the depositary receipt is comparable to that of a locally issued bond denominated in the local currency even assuming that the issuers of the two different instruments have equal financial strength and creditworthiness. This is because the currency swap being an exchange contract is likely to be covered by IMF Article VIII(2)(b). This agreement among virtually all countries in the world effectively renders the claims underlying the depositary receipt unenforceable anywhere in the world if and when that foreign country's regulators (i.e. regulators of the country that first issued or sold the underlying debt instrument) decide to make it unenforceable in their country. The risk that unenforceability is a matter within a foreign regulator's unilateral discretion stands in stark contrast to a conventional bond where enforceability of the debt claim cannot be suspended by a regulator in any country. Therefore, the risk of sovereign interference resulting in unenforceability is a major one which can make the debt instrument unmarketable to investors.

A common way to mitigate credit risk is for a counterparty to post collateral which can be readily liquidated to offset the impairment of cash flow or market value if the risk event should occur, In this case, however, collateral would be useless because it would be collateralizing an exchange contract (i.e. the currency swap) which may become unenforceable. Access to the collateral to pay for the exchange contract could therefore also be rendered unenforceable. Embodiments of the present inventions protect the investor from this risk by giving the right to the investor to sell or exchange the depositary receipt which is denominated in the local currency, and not the underlying regulated foreign currency, in the event of non-receipt of the promised cash flows by exchanging the depositary receipt for proceeds available from the liquidation of assets posted by the foreign bank which is the counterparty under the currency swap. These assets are to be held in a collateral account by the issuer of the depositary receipts. Embodiments of the present inventions protect the investor by providing a right to sell or exchange the depositary receipt, which is domestic and not foreign instrument, against the collateral assets. Both the depositary receipt and the collateral assets are denominated in a currency other than that of the currency of the foreign regulator who would otherwise be able to interfere with the enforcement of the underlying exchange contract (i.e. the currency swap). Thus the right to sell or exchange the depositary receipt in the event of non-performance is outside of the scope of IMF Article VIII(2)(b) because it does not involve the currency of the foreign country. In this way, embodiments disclosed herein protect the investors in the depositary receipt, even if the underlying exchange contract is rendered unenforceable.

The following are definitions of terms used throughout the disclosure:

“Bank A” refers to a bank operating in country A.

“Bank B” refers to a bank operating in country B.

Although bank A and bank B are used by way of example throughout this disclosure, one of skill in the art will appreciate that bank A and bank B may refer to any institution able to issue securities and/or lend funds to another institution or individual.

“Collateral Asset” or “Collateral” refers to an asset or assets pledged by the owner to secure the performance of a contract such as a foreign exchange derivative. Collateral may also refer to a person acting as guarantor to secure the performance of a contract.

“Country A,” “Country B” and “Country C” refer to three different, although unspecified, entities which must be differentiated when describing the disclosed embodiments. Each country may have its own sovereign government and territories which fall within the jurisdiction of its sovereign government. Embodiments disclosed herein do not rely on any specific country but it is necessary to clearly differentiate when discussing three different unspecified countries which are designated ‘A,’ ‘B,’ and ‘C.’ Although the term country is used throughout this disclosure, a country may refer to any entity, including a country, territory, governed area, unrecognized country or governed entity, or any other jurisdictional entity.

“Currency A” refers to a local currency of Country A.

“Currency B” refers to a local currency of Country B.

“Debt instrument” refers to a financial instrument that requires an up-front investment to acquire, returns the upfront investment at a future date and pays one or more amounts of fixed payment amounts at specified periods during the interim, all of which are denominated in a currency other than currency B. The debt instrument may be in the form of notes, bonds, redeemable preferred stock or Islamic bonds known as sukuk.

“Depositary receipt” refers to a security that acts as tradeable substitute or container for an underlying asset or assets such as a debt instrument. Depositary receipts may be in the form of Global Depositary Notes which are securities marketed by CITIBANK or a trust certificate, or an asset-pass-through security.

“Investment instrument” refers to the rights under a financial contract for the holder to receive his share of income realized by the issuer of the investment instrument which was generated by assets purchased or controlled by the issuer and which may be reduced by costs involved in financing those assets. Investment instruments may be in the form of shares of stock in a corporation, partnership shares or residual equity-like interests in a securitization vehicle. The holder of investment instrument may be a resident of country A, country B or another country.

“ISDA” refers to the International Swap and Derivatives Association, which is a trade organization of participants in the market for over-the-counter derivatives. It is headquartered in New York, and has created a standardized contract (the ISDA Master Agreement) to enter into derivatives transactions

“ISDA Master Agreement” refers to the international contractual standard for the industry created by ISDA to govern privately negotiated derivatives transactions, including foreign exchange derivatives, that reduce legal uncertainty and allow for reduction of credit risk through collateralization and/or netting of contractual obligations.

“Memory location” refers to a unit of storage such as a byte or word in a computer's main memory which may record numeric or alphanumeric values and which may be accessed by its processor using the address of its byte or first byte if consisting of more than one byte. The contents in memory location may be initialized from non-volatile computer readable media such as hard drive or flash drives.

“Synthetically denominated debt instrument” or “synthetic currency debt” refers to the combination of a fixed income instrument, such as conventional debt in the form of a bond or note, which is denominated in a currency other than currency B (for example currency A) and a currency swap (a type of foreign exchange derivative) which when set-off against opposite-direction, same-currency cash flows of the debt instrument results in net cash flows denominated in currency B.

Embodiments disclosed herein provide methods and computer systems to record income for an investor directly or indirectly owning depositary receipts. Embodiments disclosed herein also provide methods and a computer system to record income for an investor directly or indirectly owning assets which are financed by depositary receipts. Embodiments disclosed herein further provide methods and a computer system to hold and exchange collateral assets for depositary receipts in the event that certain conditions or expected cash flows are not received. The computer systems disclosed are comprised of one or more computer applications which are accessible by one or more computer processors communicating with each other through a motherboard bus, application interface, local-area network or wide-area network.

In an embodiment, an electronic, fully-automated apparatus is provided that functions without human intervention. However, other embodiments can be constructed with combinations of manual processes and electronic communications such as electronic messaging, telex, telefax, e-mail or telephone to accomplish the methods claimed.

FIG. 1A illustrates a base scenario in which problems of the prior art have been encountered. Two approaches (Scenarios I and II) that have been tried but which have not provided an adequate solution to those problems are shown. The horizontal panel labeled Base Scenario in FIG. 1A shows the objectives of the actors. Borrower A which is a resident of Country A desires to borrow funds in Currency B from Investor B which resides in Country B. Borrower A may desire to borrow Currency B so that it may invest it in Country B. The horizontal panel labeled Scenario I shows a popular approach practiced in the past that allows Borrower A to borrow funds in Currency B from investor B. This requires Borrower A to establish a business presence in Country B such as a branch in Country B which will borrow Currency B from Investor B under the laws of Country B. This business presence is required because Currency B, which Borrower A desires to borrow, is not an internationalized currency, which means that it is intended to be used only in Country B, and not for use in other countries. In contrast to non-internationalized currencies, internationalized currencies, such as the United States dollar, have issuers, such as the U.S. government, which permit it to be used outside the country where it is issued. However, establishing a local presence in Country B is often undesirable for Borrower A because it involves incurring cost or investment by Borrower A in resources and capabilities that Borrower A already possesses in Country A. In the present environment of globalization, many entities such as Borrower A which operate or invest in more than one country prefer to invest in as few facilities as possible, but to have these facilities service its needs as broadly spread out in as many countries as possible. Even if Borrower A is not required by the law of Country B to establish a branch or other kind of business presence in Country B in order to borrow Currency B, Country B may impose other costs such as withholding taxes and licensing costs that Borrower A desires to avoid. These costs render the approach shown in the horizontal panel labeled Scenario I to be inadequate and problematic.

The horizontal panel labeled Scenario II in FIG. 1A shows another approach which may be considered but which also does not work. In Scenario II, instead of lending Currency B to Borrower A in Country B, Investor B travels to Country A (either personally or through an agent) and lends Currency B to Borrower A in Country A under the laws of Country A. Since Borrower A does not have to establish a business presence in Country B or incur costs there, this approach would be preferable to Borrower A. However, the problem with this approach is that it may violate the law of Country B which does not permit the use of Currency B outside Country B. Also, Country A may be prohibited from enforcing the loan agreement between Borrower A and Investor B because of Country A's responsibilities under IMF Article VIII(2)(b). Repayment of the loan in Currency B by Borrower A from Country A may also be problematic or unenforceable because Borrower A does not have access to Currency B in Country A.

FIG. 1B further illustrates a base scenario in which problems of the prior art have been encountered and a solution to these problems, according to an embodiment FIG. 1B continues from FIG. 1A in the description of the methods of the prior art. The horizontal panel labeled Scenario III in FIG. 1B shows one approach that was practiced in the prior art to overcome the problem of non-internationalized currencies. Instead of borrowing Currency B in Country A, which is not permitted by the issuer of Currency B (the government of Country B), Borrower A issues a foreign exchange derivative such as a currency swap, whereby Borrower A agrees to repay Investor B in the future by purchasing Currency B in the foreign exchange market (which may operate in Country B) using funds in Currency A that Borrower A obtains in Country A to purchase Currency B. Although such an agreement does not violate the law of Country B because it does not require Currency B to be exported outside Country B, it creates serious risk that Investor A may not wish to undertake. This is because under IMF Article VIII(2)(b), the government of Country A has the unilateral power to prohibit the purchase of Currency B by Borrower A, thereby defeating or interfering with that contract embodied in the foreign exchange derivative. If the government of Country A were to declare such a prohibition, then the obligation of Borrower A under the foreign exchange derivative may not be performed in Country A or in any other country which is a party to the IMF articles of agreement because it violates a law or a regulation adopted in Country A. The effect of IMF Article VIII(2)(b) is to make the regulation of Country A concerning any exchange contract involving Currency A to have an extra-territorial effect throughout the IMF system. The foreign exchange derivative that was described would be affected because it calls for Borrower A exchanging Currency A for Currency B. If Borrower A is considered a systemically important financial institution in Country A, the risk of interference in the foreign exchange derivative is heightened in the event that the government of Country A makes a capital investment in Borrower A to prevent it from failing, which any government would be strongly motivated to do in order to avoid the risk of a financial crisis that could be triggered by the failure of a systemically important bank under its jurisdiction, such as Borrower A. A serious conflict of interest could then arise when the desire of the government of Country A desires to protect its investment in Borrower A influences its decision to restrict the outflow of resources from Borrower A. It can accomplish this because it has the unilateral power to block the foreign exchange derivative from being performed by Borrower A.

The widespread and usual approach taken by the industry under the prior art to protect the foreign exchange derivative from default or non-performance is to attach collateral assets to the foreign exchange derivative or to involve another party to act as a guarantor which could be called upon to assure that Borrower A performs the purchase of Currency B. The horizontal panel labeled Scenario IV shows this practice. The widespread and well known practice in the art is to specify this under the so-called Credit Support Annex which is a standard but optional rider to the ISDA Master Agreement. One of ISDA's key initiatives is to ensure the enforceability of the ISDA Master Agreement which includes the Credit Support Annex. The prior art applies the abstract idea of attaching collateral assets to guaranty a contract by actually attaching the collateral to the foreign exchange derivative through the Credit Support Annex.

The horizontal panel labeled as Solution in FIG. 1B shows an overview of how the embodiments disclosed herein work. Instead of attaching the collateral (or the guarantor) directly to the foreign exchange derivative contract, the collateral (or guarantor) is attached to a product of the foreign exchange derivative contract and another financial instrument, such as a conventional debt instrument denominated in Currency A. The integration of the foreign exchange derivative with the conventional debt instrument results in a new financial product, referred to as Synthetic Currency Debt, which is purely denominated in Currency B. Since the new financial product does not involve currency A, it is beyond the reach of IMF Article VIII(2)(b) and the government of Country A cannot interfere with this new financial product outside its territorial jurisdiction. The collateral or guarantor (shown as Collateral B), which exists outside Country A, is attached to this new financial product, instead of being attached to the underlying foreign exchange derivative, as is the widespread practice in the prior art.

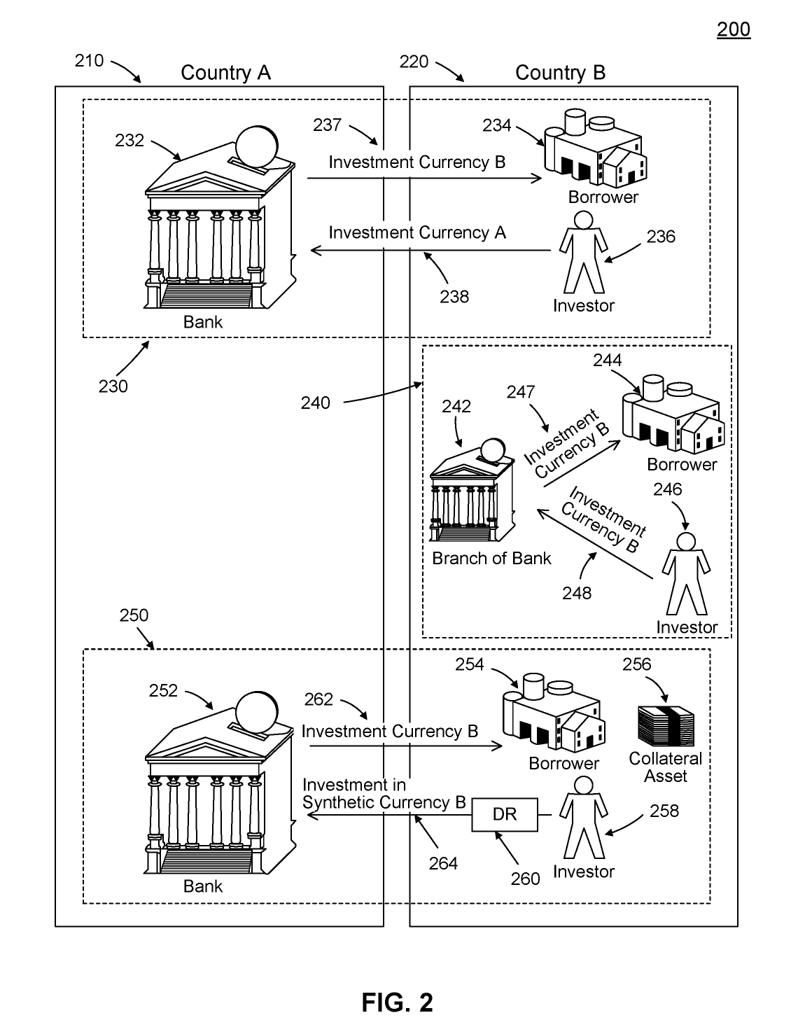

FIG. 2 illustrates a comparison of the prior art and embodiments disclosed herein. Territory 210 is shown as a vertical rectangle on the left side representing the territory and jurisdiction of country A. Bank 232 and bank 252 are entities which are within the territory 210 and under the jurisdiction of country A. Territory 220 is shown as a vertical rectangle on the right side representing the territory and jurisdiction of country B. Borrower 234, investor 236, branch 242, borrower 254 and investor 258 are entities which are within the territory 220 and under the jurisdiction of country B. Three sets of actions are shown and are denoted by broken line rectangles or squares. Action set 230 and action set 240 show prior-art practices. On the other hand, action set 250 represents the use of embodiments of the present inventions.

Virtually all emerging market countries do not permit non-residents to freely borrow their national currency from residents. In the case of country A, bank 232 is not permitted by country B to borrow currency B from residents in country B. Likewise, borrower 234 is not permitted to borrow currency A from any resident in country A including bank 232. Normally this is not a problem for borrowers such as borrower 234 who is operating exclusively in country B and earning revenues which are denominated in currency B. Borrower 234 strongly prefers to borrow in currency B so as to match its earnings which are in the local currency (currency B). However, this is a problem for bank 232 that wishes to engage in financial intermediation. Normally banks do this by borrowing funds from investors or depositors, which they then on-lend to borrower customers. The problem with the prior art is that although bank 232 desires to lend borrower 234 in the latter's local currency (currency B) as shown by lending transaction 237, it is unable to borrow this local currency. It can borrow from residents in country B, such as investor 236, however this borrowing will have to be denominated in a currency other than currency B. In the example shown, bank 232 has been able to borrow currency A from investor 236. Investor 236 has its own savings which may be in currency B which investor 236 may exchange into currency A. Unlike a bank, investor 236 does not engage in financial intermediation and therefore does not need to borrow the funds that it lends, nor does it need to match the currency denomination of its assets and liabilities, assuming that it has any liabilities. As a result of lending transactions 237 and 238, bank 232 is experiencing a currency mismatch between its loan receivable from borrower 234 which is denominated in currency B versus its liabilities to investor 236 which are denominated in currency A.

The financial problem shown in action set 230 may be addressed by bank 232 by establishing a branch or subsidiary to engage in the banking business within country B, as shown within action set 240. The branch of bank 230 is shown as branch 242. Since branch 242 is a resident of country B, it is permitted to borrow currency B from local residents such as investor 9023 as shown by transaction 248. Branch 242 can then on-lend the proceeds of transaction 248 to borrower 244 in a financing which is denominated in the same currency B as its borrowing. This on-lending is shown as transaction 247. Thus branch 242 is able to match assets and liabilities on its balance sheet in the same currency. The problem for bank 232 with this prior-art practice as shown by action set 240 is the overhead cost of operating a foreign branch and also the limited amount of bank capital that may be assigned to the branch 242 which limits the amount of assets that can be carried on the books of branch 242.

Action set 250 shows use of embodiments of the present inventions. In an embodiment, bank 252 is able to lend in currency B to borrower 254 while effectively financing this with a synthetic denominated debt instrument financing which is synthetically denominated in currency B from investor 258 as shown by transaction 264. Note that bank 252 has not actually borrowed in currency B, as it is not legally permitted to do so. Instead bank 252 has achieved something very similar to borrowing currency B through the use of embodiments of the present inventions, which enable bank 252 to issue synthetically denominated debt which is then purchased by a depositary bank, which in turn issues depositary receipt 260 to investor 258. The process creating the depositary receipt 260 will be discussed in more detail in the following drawings. By using the embodiments disclosed herein, bank 252 has been able to match the currency of its assets and liabilities which is something that it could not accomplish by using the prior art without establishing a branch or subsidiary in country B. At the same time, investor 258 is able to protect itself from being unable to receive cash flow in currency B due to sovereign interference occurring in country A by having the right to exchange the depositary receipt 260 for the collateral asset 256.

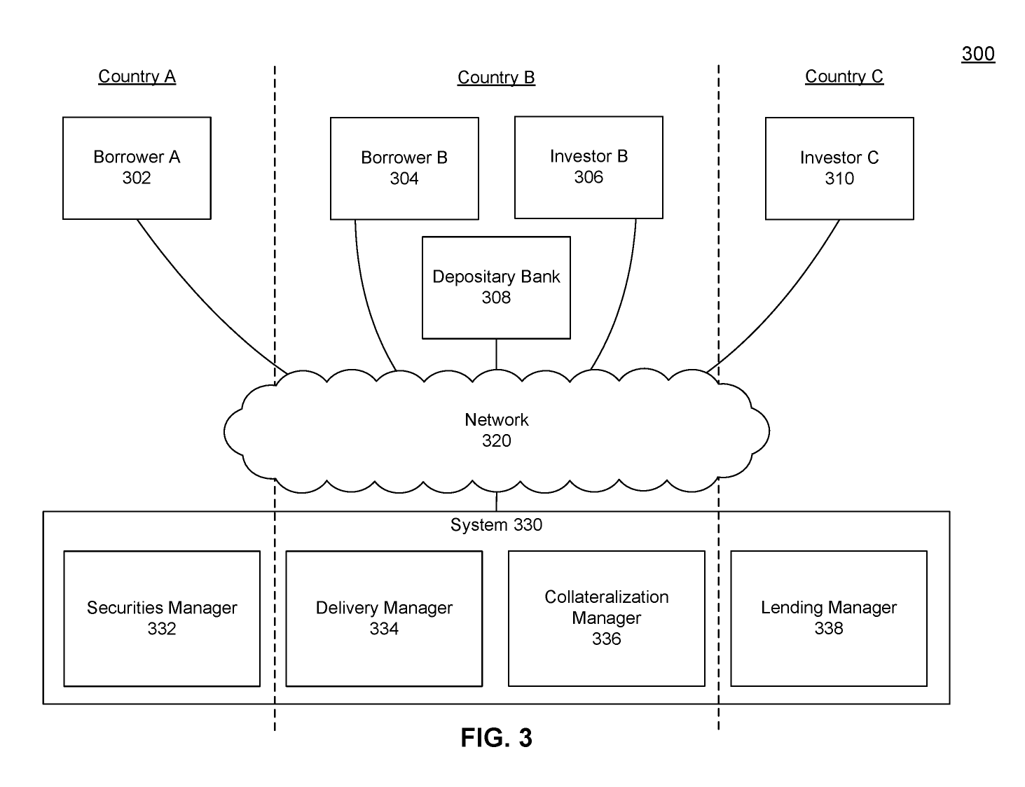

FIG. 3 is an example system for collateralizing and investing in synthetically denominated debt instruments, according to an embodiment. System 330 includes securities manager 332, delivery manager 334, collateralization manager 336, and lending manager 338. System 330 may be coupled via network 320 to investor A in country A 302, borrower B 304, investor B 306 and depositary bank 308 in country B, and investor C 310 in country C. Network 320 may be any type of network capable of communicating data, for example, a local area network, a wide-area network (e.g., the Internet), public switched telephone network (PSTN), or any combination thereof. Countries A, B, and C are different countries and arbitrarily labeled for ease of reference, and may refer to any jurisdictional entity, including a country.

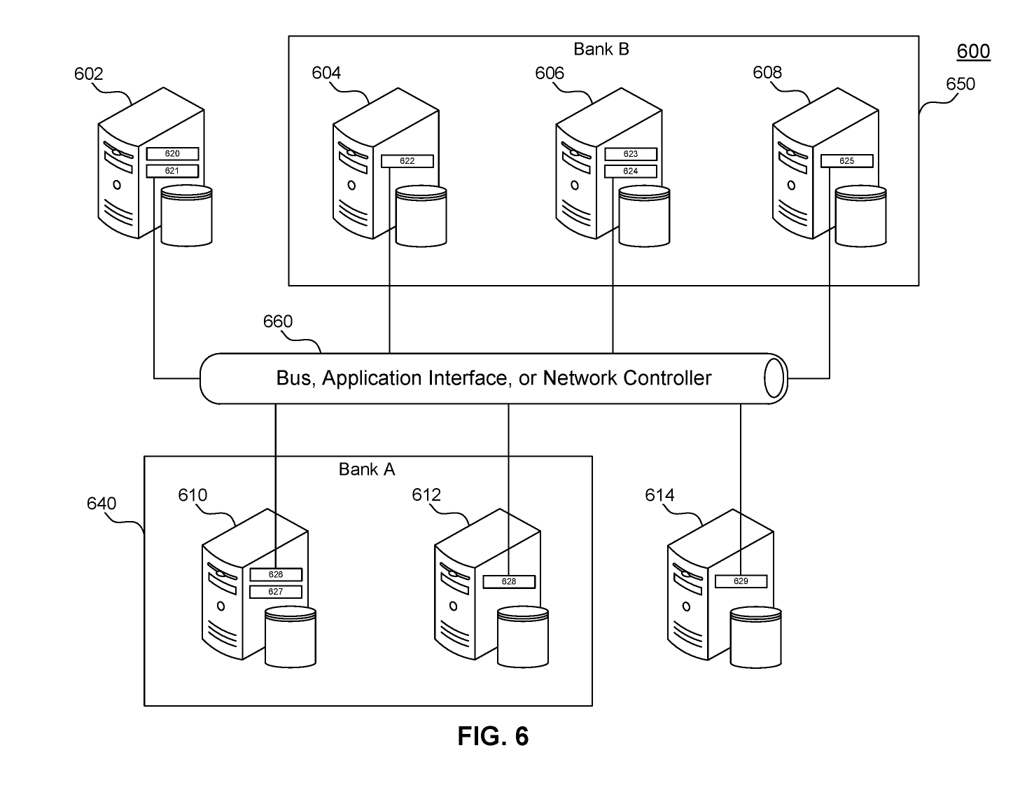

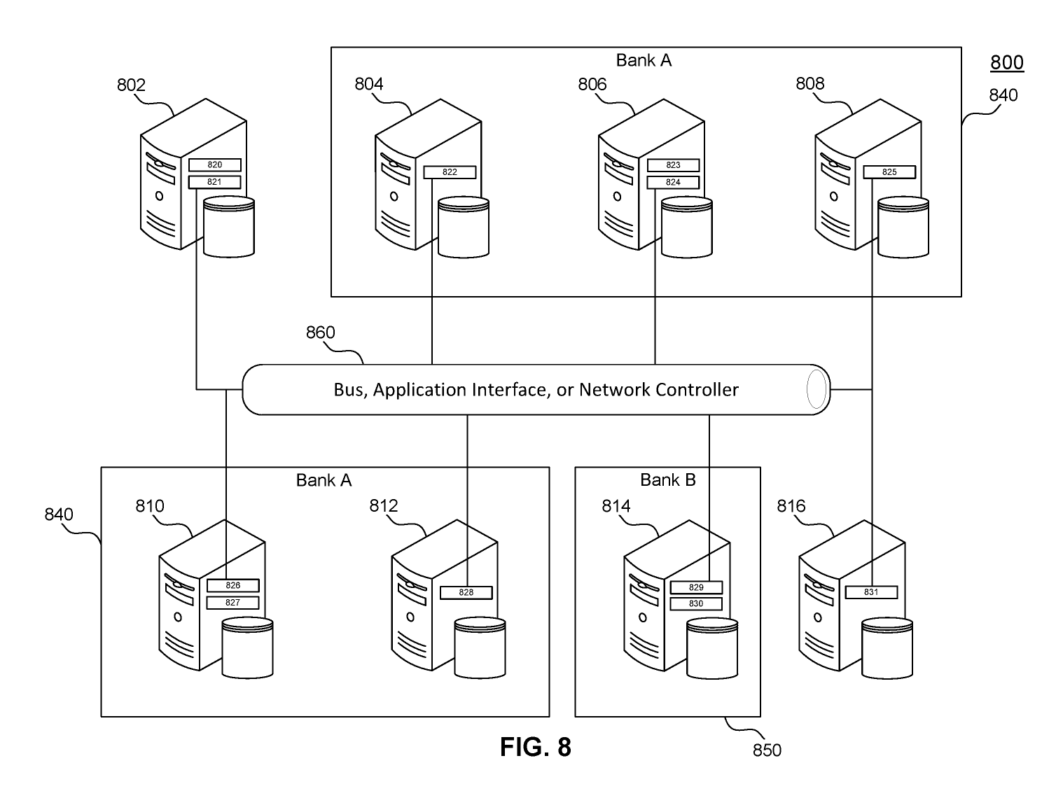

Securities manager 332, delivery manager 334, collateralization manager 336, and lending manager 338 may be implemented as part of system 600 of FIG. 6 and/or system 800 of FIG. 8, as described further below. In an embodiment, securities manager 332 issues a debt security in country A that is denominated in a local currency of country A. Securities manager may also issue a currency swap on the debt security that specifies exchange of cash flows in local currency of country A for cash flows in a local currency of country B. In an embodiment, securities manager 332 works with or is controlled by Borrower A, and the debt security and currency swap may both be issued by Borrower A. In an embodiment, securities manager 332 may then create a synthetically denominated debt instrument that is a combination of the issued debt security and the currency swap. As discussed previously, this effectively acts as a debt security issued in the local currency of country B.

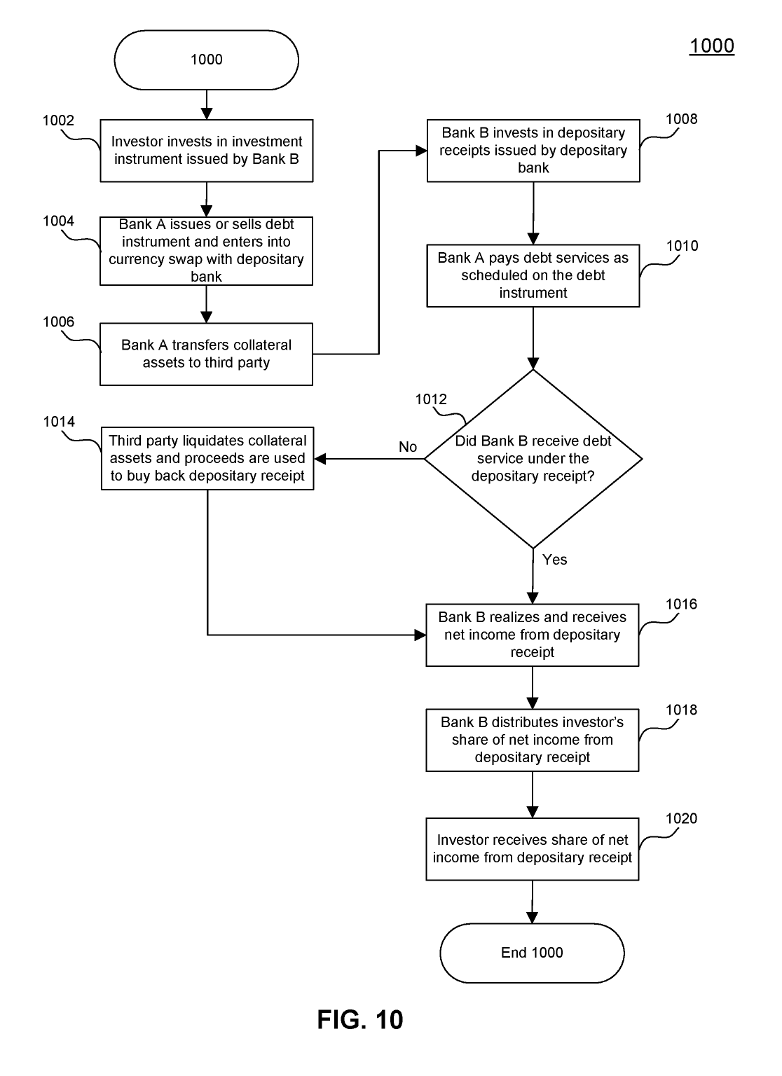

In an embodiment, delivery manager 334 delivers the synthetically denominated debt instrument to depositary bank 308. Depositary bank 308 may then issue a depositary receipt representing the synthetically denominated debt instrument, and investor B 306 may invest in the depositary receipt. Investor B 306 may further issue an investment instrument that entitles an investor to income derived from the depositary receipt, as described further with respect to FIG. 10. Investor C 310 in country C may invest in the issued investment instrument.

In an embodiment, collateralization manager 336 posts collateral assets in country B denominated in the local currency of country B. Collateralization manager 336 may then attach the collateral assets to the depositary receipt, and the depositary receipt may be exchanged by investor B 306 for the collateral assets in the event of non-payment of promised cash flows on the synthetically denominated debt instrument by Borrower A.

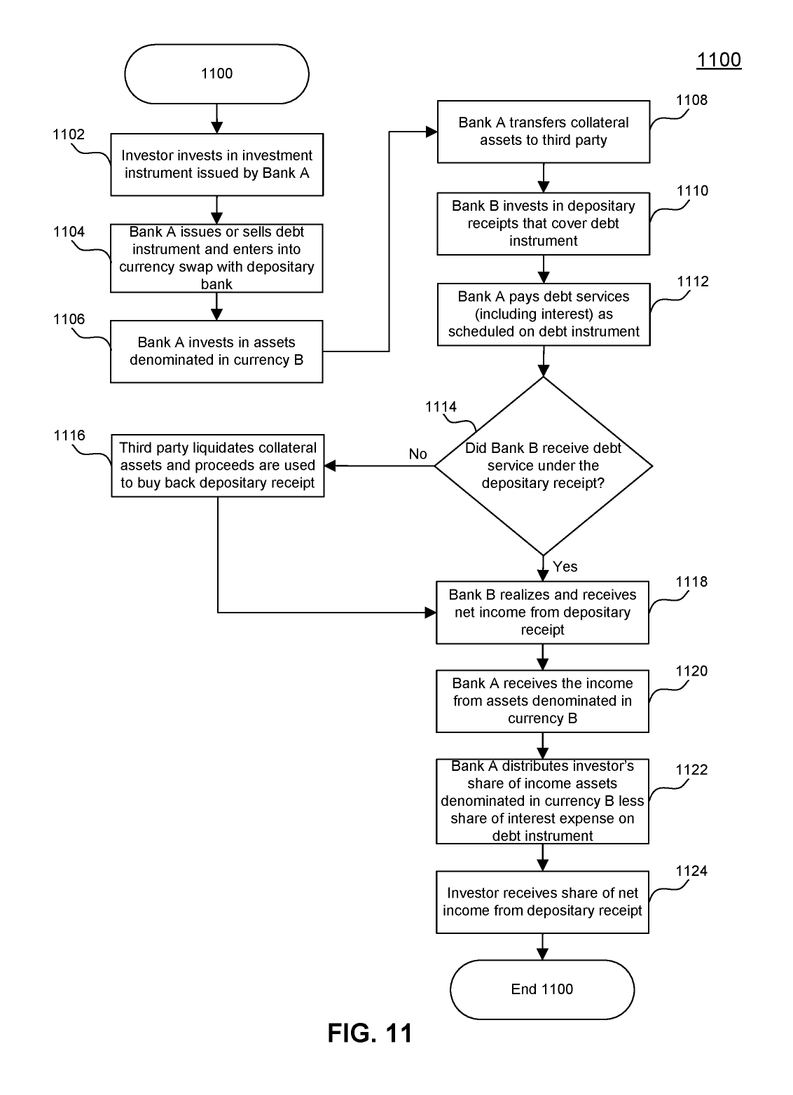

Borrower A 302 may use proceeds received from investment in the synthetically denominated debt instrument to lend funds in the local currency of country B to Borrower B 304 in country B. In an embodiment, lending manager 338 lends the proceeds received from investment in the synthetically denominated debt instrument to Borrower B 304. Borrower A 302 may further issue an investment instrument that entitles an investor to income derived from financial assets denominated in the local currency of country B that are financed by the synthetically denominated debt instrument, as described further with respect to FIG. 11. Investor C 310 in country C may invest in the issued investment instrument.

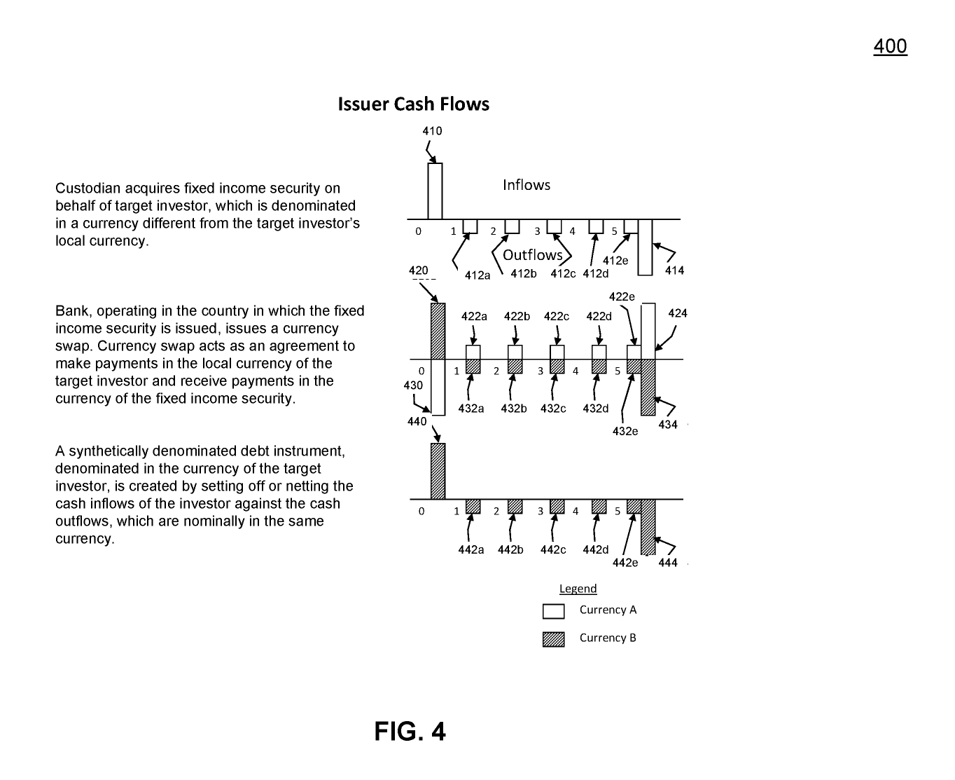

FIG. 4 is a diagram illustrating how synthetically denominated debt is created from the perspective an issuer of an underlying debt instrument, according to an embodiment. The embodiment shown in FIG. 4 is a debt instrument with a five (5) year term and which pays interest coupons annually. Other embodiments may have longer or shorter durations than five years. Other embodiments may also have forms of coupon income other than interest income such as preferred stock dividends or lease payments under a sukuk bond. The cash flows shown are from the point of view of the issuer of the underlying debt. This issuer is a resident of country A whose local currency is currency A. The issuer may be a bank or other financial institution operating within the territory of country A. Cash flows above the line represent cash inflows for the issuer while cash flows beneath the line represent cash outflows for the issuer. In stage 1, the issuer issues or sells a debt instrument which is denominated in currency other than currency B, for example currency A, which is the local currency of the issuer. Cash flow 410 shows the cash inflow of the issuer representing the sale proceeds or issuance proceeds of selling or issuing the debt instrument. In the following years, marked by the numbers 0 through 5 just beneath the horizontal line, the issuer or seller expects cash outflows representing coupon payments as shown by cash flows 412a, 412b, 412c, 412d and 412e. If the seller has sold the debt instrument out of its portfolio, as opposed to having issued it, then the outflows shown by cash flows 412a, 412b, 412c, 412d and 412e represent foregone cash inflows rather than out-of-pocket cash outflows. Finally, there is a cash outflow shown as cash flow 414 representing the principal amount which is paid at the maturity of the debt. Stage 2 of FIG. 4 shows the cash flows of the currency swap (or exchange contract). This kind of currency swap is often called a cross-currency swap, which is a contract between two parties to exchange interest payments and principals denominated in two different currencies. Unlike non-deliverable currency swaps such as non-deliverable forwards, this currency swap involves actual delivery and receipt of two different currencies.

Looking at the exchange of currencies during the first period 0, a cash inflow in currency B is shown by cash flow 420. Simultaneous with this inflow is an outflow of currency A represented by cash flow 430. Although it appears that cash flow 420 and cash flow 430 represent the same quantity but denominated in different currencies, the exchanged quantities need not be equal except when the spot exchange rate between currency A and currency B is 1:1.

In the periods that follow the initial period, the issuer, which is also the counterparty under the currency swap, receives currency A as shown by cash flow 422a, As a condition for the right to receive the amount as shown by cash flow 422a, the issuer has the obligation to pay the amount of currency B as shown by cash flow 432a. The amount shown by cash flow 432a is the amount expected by the depositary receipt investor which corresponds to the income for period 1 that the investor expects to receive. How this works will be more clearly explained in the discussion for stage 3 below. In each of the periods that follow period 1, there is a similar exchange of currency A for currency B as shown by amounts represented by cash flow 422b in exchange for the amount shown as cash flow 432b at the end of period 2, amounts represented by cash flow 422c in exchange for the amount shown as cash flow 432c at the end of period 3 and for similar exchanges all the way through period 5 as can be seen in the diagram for stage 2. At the end of the term, which for the embodiment shown is period 5, there is a final exchange of currencies representing the repayment of principal. The issuer receives an inflow of currency A as shown by cash flow 424 in exchange for an outflow (i.e. payment by issuer) of currency B as shown by cash flow 434. The amounts exchanged during the last period is usually larger than the amounts exchanged during the previous periods if the underlying debt is in the form of a balloon obligation such as a conventional bond with interest-only coupons during the interim periods before maturity.

The diagram in stage 3 of FIG. 4 shows the net cash flows that are received by the issuer and paid by the issuer after subtracting flows as shown from the diagram in stage 2 from the flows of the same currency which are in the opposite direction as shown in stage 1 of FIG. 4. The cash flows shown by the vertical bars shaded in gray, which are all the cash flows, represent the synthetic fixed income security which is a single financial instrument resulting from the integration of the contractual cash flows shown in stage 1 and stage 2 of FIG. 4. A flow as shown in the diagrams of either stage 1 or stage 2 may not even be paid or received by the investor as it is settled by set-off against another flow which is due in the opposite direction. Therefore, there will be no cash-in or cash-out for these currency amounts. Because of this set-off in inflows and outflows of the same currency, the net cash flow from the combined investment is shown in stage 3 of FIG. 4 wherein cash flow 440 shows the net cash inflow in the currency of country B and period net cash outflows each period from period 1 through 5 of 442a through 442e representing interest payment flows. There is also shown a net cash outflow from the issuer at the end of period 5 as shown by the cash flow 444. Although there has been no actual issuance of a debt instrument denominated in currency B, the end result after offsetting of cash flows from the underlying debt instrument shown in stage 1 and the currency swap shown in stage 2 is very similar to the cash flows that an issuer would incur by issuing a plain vanilla debt instrument which is denominated in currency B, although that issuer may not be permitted to issue a debt instrument which is naturally denominated in currency B. The resulting stream of cash flows shown under stage 3 of FIG. 1 is a synthetically denominated debt instrument which is synthetically denominated in currency B. Note that the bank referred to in stage 2 has no counterparty risk in the currency swap shown in stage 2 because its receivables under the currency swap are paid by the cash flows shown in stage 1, which are the obligations of the same bank. Therefore, the counterparty of the bank in the currency swap is effectively itself. Since it is not logically possible for a bank to have counterparty risk, or credit risk of any kind, against itself, this means that the bank has no counterparty risk. This is an important difference arising from the embodiments of present inventions compared to the prior art in which a bank engaging in a currency swap has counterparty risk because the counter party is another party different from the bank.

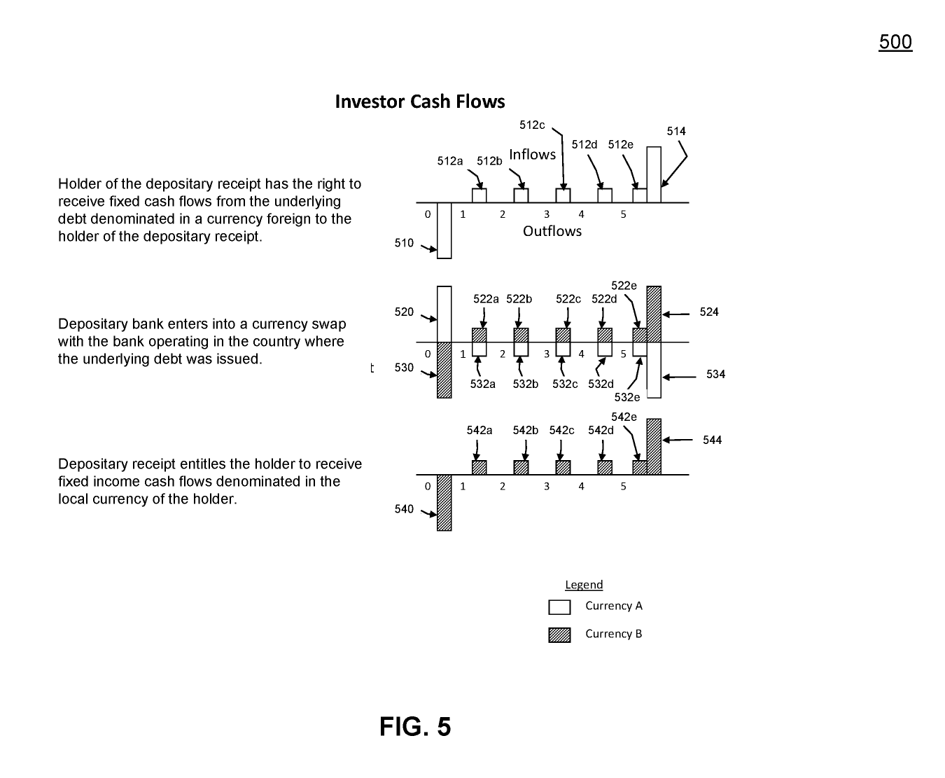

FIG. 5 is a diagram illustrating how synthetically denominated debt is created. from the perspective of an investor, according to an embodiment. FIG. 5 shows the same instruments which were discussed in FIG. 4; however, the cash flows are presented from the point of view of the investor in the depositary receipt, instead of the issuer of the debt instrument underlying the depositary receipt. The investor shown is a resident of country B, whose local currency is currency B. The cash flows in stage 1 in FIG, 5 is a mirror image of the cash flows in stage 1 in FIG. 4. Stage 1 of FIG. 1 shows the debt instrument which is purchased for the investor by the bank depositary that will issue the depositary receipt through a series of outflows and inflows which are denominated in currency A, which is foreign to the investor. Cash flow 510 shows the amount in currency A that must be paid to purchase the debt instrument. This amount under the debt instrument corresponds to the investment in the depositary receipt, but after the cash flow shown in cash flow 510 denominated in currency A has been converted to the cash flow shown as cash flow 540 denominated in currency B. As income on the debt instrument underlying the depositary receipt, the investor is to receive the income payments (i.e. coupons) as shown by cash flows 512a, 512b, 512c, 512d and 512e. At the maturity of the investment as shown by stage 1 in FIG. 2, the investor is to receive a bullet principal repayment denominated in currency A as shown by cash flow 514. This embodiment shows a conventional bullet type bond in which only interest is paid during each period during the term. Other embodiments may have level or near-level payments comprised of interest and principal which are required to be paid during those interim periods. It is also possible to use the invention when only a zero-coupon payment is paid at the end of the term, which represents both the income and return of principal to the investor.

Stage 2 of FIG. 5 shows the currency swap from the point of view of the investor. During the first period, the investor receives an amount in currency B as shown by cash flow 520. This amount is structured to be equal to the amount in stage 1 of FIG. 5 which is shown by cash flow 510. In exchange for the right to receive the amount shown as 520, the currency swap obligates the receiver of the amount shown as cash flow 520 to pay the amount shown as cash flow 530. In this example, the quantities shown by cash flow 520 and 530 seem to be equal in amount because the exchange rate between the two currencies is 1:1 however this exchange rate need not be the case for the embodiments of the present inventions to be utilized. In the periods that follow, the currency that the investor receives versus what the investor pays is reversed. In the example shown, the investor receives an amount in currency B as shown by cash flow 522a, with an obligation on the investor (or his agent such as depositary bank) to pay the amount shown by cash flow 532a. A similar series of exchanges of currencies can be seen with respect to the receivable amounts in currency B shown by cash flows 522b through 522e in exchange for the cash payments (outflows) in currency A shown by cash flows 532b through 532e. At the end of the term, which is shown as period 5, the investor receives a final amount in currency B as shown by cash flow 524 in exchange for payment of the amount in currency A as shown by cash flow 534.

Stage 3 of FIG. 5 shows the net cash flows after setting off the flows in stage 1 of FIG. 5 with the flows in the same currency but in the opposite direction as shown by stage 2 of FIG. 5. After netting, the remaining cash flows in currency B are so similar to that of a plain vanilla conventional bond issue which is denominated in currency B that the synthetically denominated bond can substitute for the latter in the market place.

FIG. 6 is a diagram illustrating investment in an investment instrument that allows the investor to participate in income from depositary receipts, according to an embodiment. This embodiment features a distributed application running on several processors and orchestrated through a network, bus or application interface. Other embodiments may involve a single application running on a single processor or multiple applications running within a cloud architecture.

Communication infrastructure 660 shows the infrastructure through which the memory locations shown in this embodiment are accessed by one or more computer processors through the motherboard bus when the memory locations are accessible by a single computer application. The single application may in turn rely on an application interface such as RPC (remote procedure calls) if there are two or more applications within a system of distributed applications running on a single processor. If the two or more applications are running on more than one processor, such as illustrated with computer systems 602-614, the communication infrastructure 660 can transmit inter-application messages over a local-area or wide-area network, using, for example, the TCP-IP standard. The computer application or applications accessing the memory locations discussed herein may be stored on computer readable media.

Memory location 620 holds the numerical value of the income that an investor in the investment instrument receives from his investment in the investment instrument, which may be in the form of shares of stock in a bank or other company, which invests in or controls depositary receipts, Memory location 621 holds the numerical value of that investor's investment in the said investment instrument which may be periodically marked to market. Memory location 622. holds the numerical value from the point of view of the issuer of the investment instrument with respect to the claims of the holders of the investment instrument. This memory location may hold the aggregate value for all investors holding investment instruments issued by the company. Also the value in memory location 622 may be subdivided between other memory locations representing sub-accounts but which all sum up or roll up to the value stored in memory location 622. Memory location 623 holds the carrying value on the books of the bank or other company which has invested in the depositary receipts. Memory location 624 holds the accrued interest income derived by the said bank or company which it earned by investing in the depositary receipt. Memory location 625 holds the value of the cash accounts in which the proceeds of interest income and/or principal repayments arising from the depositary receipt are deposited. Memory locations 622, 623, 624 and 625 normally hold values directly pertaining to the accounting books and records of a bank (such as bank B) or other company located in Country B which has invested in the depositary receipt.

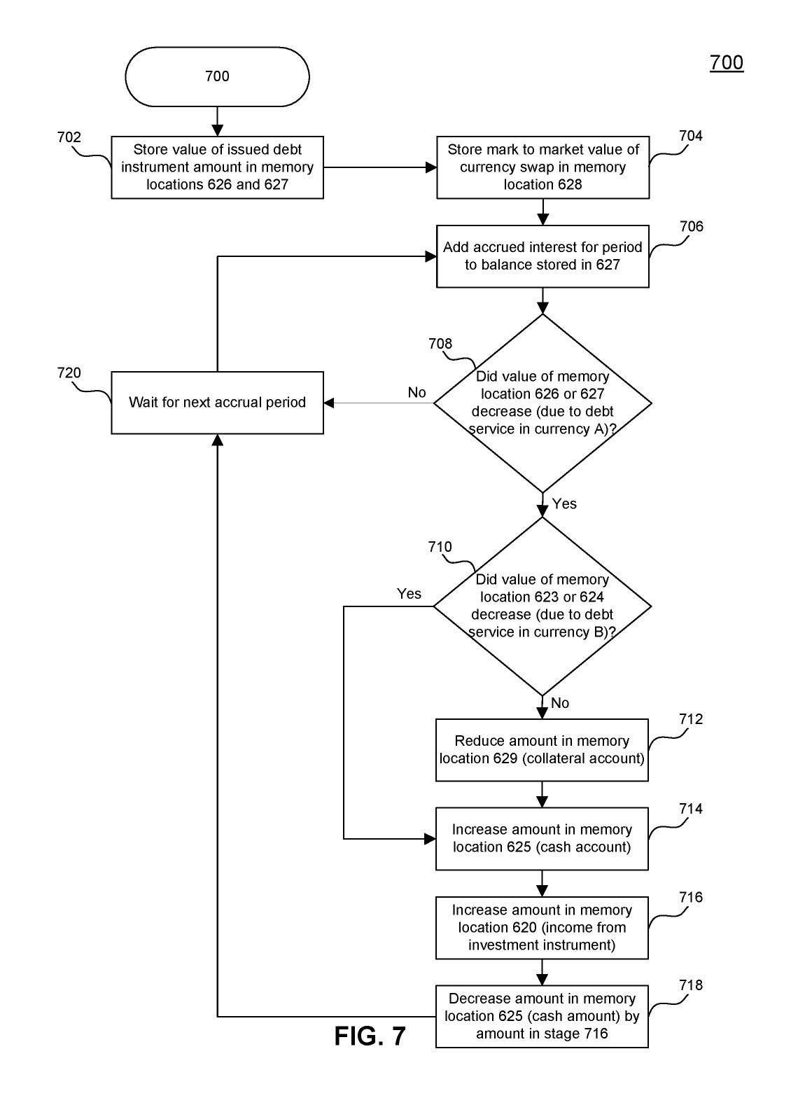

Memory location 626 holds the carrying value of the debt instrument shown in stage 1 in FIG. 1, The value in memory location 626 normally correspondents to a credit balance on the books of the issuer or seller of the said debt instrument. Memory location 627 holds the accrued interest expense attributable to the said debt instrument. Memory location 628 holds the credit or debit numerical value representing the marked-to-market value of the currency swap component of the depositary receipt which is shown as stage 2 in FIG. 5. Memory locations 626, 627 and 628 normally correspond to amounts represented on the accounting books and records of the issuer or seller of the said debt instrument. Memory location 629 holds the numerical value of collateral assets which are denominated in a currency other than currency A. These collateral assets are located outside the territory of country A. These collateral assets are normally held by a different party from the bank or company in country A which issued or sold the debt instrument underlying the depositary receipt. The said collateral assets may be liquidated to finance the exchange or redemption of the depositary receipts in the event of certain conditions as shown in the flowchart contained in FIG. 7.

FIG. 7 is an example method for investing in an investment instrument that allows the investor to participate in income from depositary receipts, according to an embodiment, according to an embodiment. In particular, FIG. 7 shows the stages of how to use the system shown in FIG. 6. At stage 702, the value of the debt instrument is stored in memory location 626 and 627. Memory location 626 holds the value of the principal amount of the debt instrument which is the underlying asset of the depositary receipt. Memory location 627 holds the value of interest expense accrual to date with respect to the said debt instrument. Both values refer to currency amounts denominated in currency A, or some other currency which is not currency B. The values held in memory location 626 and 627 may both map to the accounting statements of the issuer of the debt instrument.

At stage 704, the marked-to-market value of the currency swap shown in stage 2 of FIG. 4 is stored in memory location 628. Normally at the initiation of the currency swap, its market value is zero because the present value of the cash flows in currency A and the present value of the cash flows in currency B are equal. However, over time, the present value of the former may become greater or lesser than the latter depending on how exchange rates and interest rates change with respect to the two different currencies. The value stored in memory location 628 is normally the marked-to-market value expressed in currency A.

At stage 706, the interest amount for the accrual period set by issuer's accountants is calculated and added to the value stored in memory location 627 based on the promised interest rate borne by the debt instrument as shown in stage 1 of FIG. 4. This amount of interest accrued is added to previous amount of accrued interest and the sum is stored in memory location 627.

At stage 708, a determination is made as to whether the value stored in memory location 626 or 627 has changed since the end of the previous accrual period. The value of memory location 626 would be reduced if all or some of the principal amount of the debt instrument shown in stage 1 of FIG. 4 has been amortized or paid by the issuer Similarly, the value of memory location 627 holding the amount of accrued interest will also decline if some or all of the accrued interest amount is paid by the issuer of the debt instrument. If interest or principal payments were required or scheduled to be paid under the debt instrument during the previous accrual period, no decrease in the respective values of 626 or 627 from their values at the previous accrual period means that the issuer of the debt instrument failed to make the required or scheduled payment.

If the result of the determination at stage 708 is “no,” meaning that there has been no change in the value stored in memory location 626 or 627 from their respective values at the end of the previous accrual period, then the computer process waits for the end of the next accrual period and once again performs the same operation as shown in stage 706 for that accrual period.

On the other hand, if the result of the determination at stage 708 is yes, meaning that there has been a change in the value stored in memory location 626 or 627 from their respective values at the end of the previous accrual period, then another determination is made at stage 710 to determine whether the value of memory location 624 and/or 30005 p has declined from their respective values at the end of the previous accrual period. The value held in memory location 627 directly corresponds to that of memory location 624 except that the former is denominated in currency A while the latter is denominated in currency B. The amount by which memory location 624 decreased should be equal to the value of the decrease in memory location 627 multiplied by the exchange rate expressed as value of currency B over value of currency A. The same relationship is applicable to the decrease realized in memory location 623 with respect to memory location 626 except that the values in those memory locations pertain to the principal amounts of the depositary receipt and its underlying debt instrument respectively. A decrease in the value stored in memory location 626 without a corresponding decrease in the value stored in memory location 623, or similarly, a decrease in the value stored in memory location 627 without a corresponding decrease in the value of memory location 624 means that there has been a failure by the counterparty in the currency swap as shown by stage 2 in FIG. 4 (i.e. bank A) to perform some or all of the contracted exchange of currencies scheduled for that period. This failure to perform might be caused by failure of the bank itself to perform or because of regulations imposed by the authorities in country A that make it impossible for the swap contract to be performed. The debt service in currency A with respect to the debt service has been paid in country A but there has been a failure to convert that amount to currency B and transfer to depositary receipt investors in country B.

Regardless of the reason for non-performance under the currency swap as determined at stage 710, if the answer at this stage is “no,” meaning that debt service under the depositary receipt has not been received by the holder of the depositary receipt, the process then moves on to stage 712 in which the value of the memory location 629 is reduced following the liquidation of the collateral account as stored in memory location 629 into currency B. Following the decrease in the value stored in memory location 629, the value stored in memory location 625 is increased at stage 714 due to the transfer of proceeds from liquidation of the said collateral account. The amount of the increase in the value stored in memory location 625 represents the amount of debt service (i.e. interest and principal) which should have been received from the depositary receipt but which was not actually received.

On the other hand, if the result of the determination at stage 710 is “yes,” then this means that the debt service scheduled under the depositary receipt has been received and from stage 710, the process moves directly to stage 714 where the value stored in memory location 625 is increased. Thus, the memory location 625 is increased by either the (a) receipt of the scheduled debt service under the depositary receipt or (b) by liquidation of the said collateral assets depending on the answer to the determination in stage 710.

At stage 716, the value stored in memory location 620 is increased by the payment of income by the issuer of the investment instrument to the holder of the investment instrument. The value stored in memory location 620 represents the income received by the holder of the investment instrument. Thus the holder of the investment instrument is able to participate in the income generated by the depositary receipt even if legal title to the depositary receipt may not be held by that holder of the said investment instrument. Following the increase of the value stored in memory location 620, at stage 718 the value stored in memory location 625 which represents cash held directly or indirectly by the issuer of the investment instrument is decreased because that cash was distributed to the holder of the investment instrument in stage 716. After stage 718, the process proceeds to stage 720 where the previously described stages are recycled for the next accrual period.

FIG. 8 is a diagram illustrating investment in an investment instrument that allows the investor to participate in income earned from the assets financed by the issuance or sale of the debt instrument which underlies a depositary receipt, according to an embodiment. This embodiment features a distributed application running on several processors and orchestrated through a network, bus or application interface. Other embodiments may involve a single application running on a single processor or may involve multiple applications running within a cloud architecture.

Communication infrastructure 860 shows the infrastructure through which the memory locations shown in this embodiment are accessed by one or more computer processors through the motherboard bus when the memory locations are accessible by a single computer application. The single application may in turn rely on an application interface such as RPC (remote procedure calls) if there are two or more applications within a system of distributed applications running on a single processor. If the two or more applications are running on more than one processor, such as illustrated with computer systems 802-816, the communication infrastructure 860 can transmit inter-application messages over a local-area or wide-area network, using, for example, the TCP-IP standard. The computer application or applications accessing the memory locations discussed herein may be stored on computer readable media.

Memory location 820 holds the numerical value of the income that an investor in the investment instrument receives from his investment in the investment instrument, which may be in the form of shares of stock in a bank or other company, which invests in assets denominated in currency B. These assets are financed by issuing or selling the debt instrument shown in stage 1 of FIG. 4 and exchanging the proceeds for currency B as shown by stage 2 in FIG. 4. Memory location 821 holds the numerical value of that investor's investment in the said investment instrument which may be periodically marked to market. Memory location 822 holds the numerical value from the point of view of the issuer of the investment instrument with respect to the claims of the holders of the investment instrument. This memory location may hold the aggregate value for all investors holding investment instruments issued by the company. Also, the value in memory location 822 may be subdivided between other memory locations representing sub-accounts but which all sum up or roll up to the value stored in memory location 822. Memory location 829 holds the carrying value on the books of the bank or other company which has invested in the depositary receipts. Memory location 830 holds the accrued interest income derived by the said bank or company which it earned by investing in the depositary receipt. Memory location 825 holds the value of the cash accounts in which the proceeds of income and/or principal repayments arising from investments financed by the issuance or sale of the debt instrument underlying the depositary receipt are deposited. Memory location 825 also stores the remaining amount of cash after interest and principal payments on the debt instrument (stage 1 of FIG. 4) and the currency swap (stage 2 of FIG. 4) are withdrawn from. Memory locations 822, 823, 824, 825, 826, 827 and 828 normally hold values directly pertaining to the accounting books and records of a bank or other company located in Country A which has invested in assets financed by the issuance of the synthetically denominated debt instrument underlying the depositary receipt. Memory locations 829, and 830 normally hold values directly pertaining to the accounting books and records of a bank or other company located in country B which has invested in the depositary receipt.

Memory location 826 holds the carrying value of the debt instrument shown in stage 1 of FIG. 1. The value in memory location 826 normally correspondents to a credit balance on the books of the issuer or seller of the said debt instrument. Memory location 827 holds the accrued interest expense attributable to the said debt instrument. Memory location 828 holds the credit or debit numerical value representing the marked-to-market value of the currency swap (stage 2 of FIG. 5) component of the depositary receipt. Memory location 823 holds the investment value of assets which are denominated in currency A and which are controlled by the issuer of the investment instrument which memory locations 820 and 821 pertain to. Memory location 824 holds the accrued income derived from the said currency A assets.

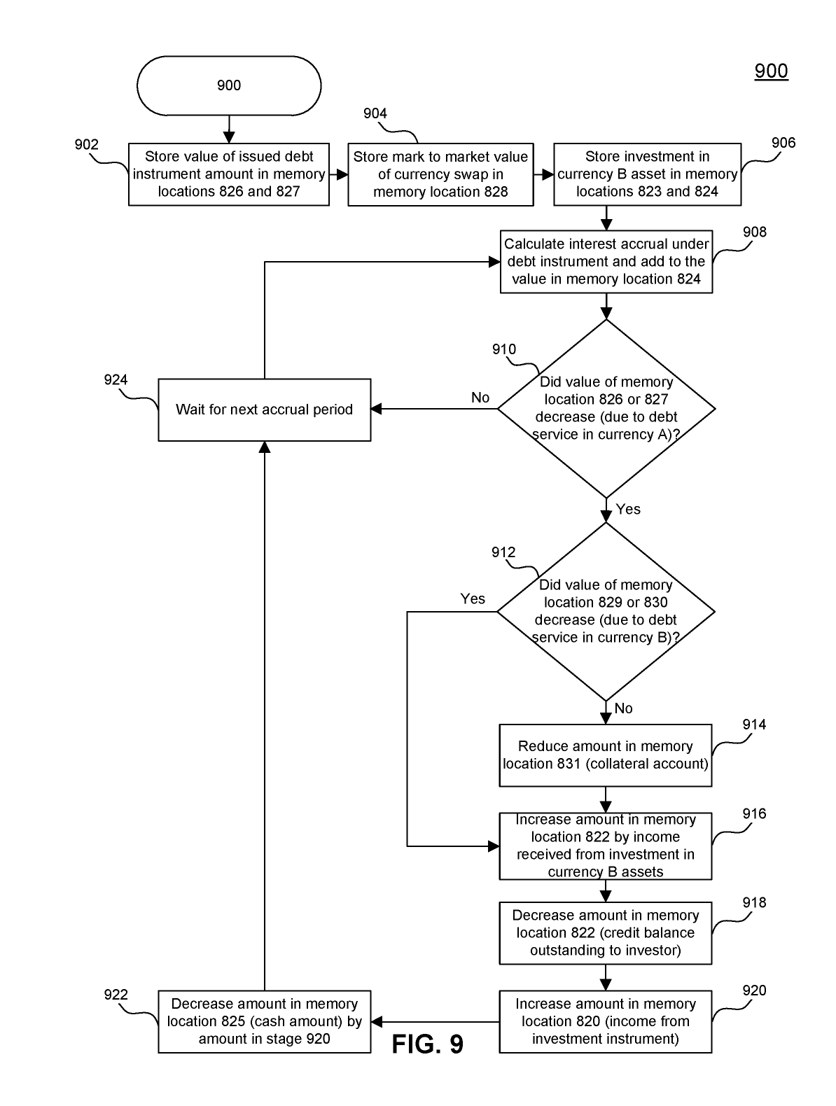

Memory location 831 holds the numerical value of collateral assets which are denominated in a currency other than currency A. These collateral assets are normally held by a different party from the bank or company in country A which issued or sold the debt instrument underlying the depositary receipt. The said collateral assets may be liquidated to finance the exchange or purchase of the depositary receipts in the event of certain conditions as shown in the flowchart contained in FIG. 9.

FIG. 9 is an example method for investing in an investment instrument that allows the investor to participate in income earned from assets financed by the issuance or sale of a debt instrument which underlies a depositary receipt, according to an embodiment, according to an embodiment. In particular, FIG. 9 shows the stages of using the system shown in FIG. 8. At stage 902, the value of the debt instrument is stored in memory location 826 and 827. Memory location 826 holds the value of the principal amount of the debt instrument which is the underlying asset of the depositary receipt. Memory location 827 holds the value of interest expense accrual to date with respect to the said debt instrument. Both values refer to currency amounts denominated in currency A. The values held in memory location 826 and 827 may both map to the accounting statements of the issuer of the debt instrument.

At stage 904, the marked-to-market value of the currency swap shown in stage 2. of FIG. 4 is stored in memory location 828. Normally at the initiation of the currency swap, its market value is zero because the present value of the cash flows in currency A and the present value of the cash flows in currency B are equal. However, over time, the present value of the former may become greater or lesser than the latter depending on how exchange rates and interest rates change with respect to the two different currencies. The value stored in memory location 828 is normally the marked-to-market value expressed in currency A.

At stage 906, the value of the principal amount of investment in an asset denominated in currency B is stored in memory location 823 and the income accrued from that asset is stored in memory location 824. At stage 908, the amount of accrued interest for the accrual period is calculated for the asset denominated in currency B and that amount of accrued interest is added to the previous period's value at memory location 824 and the resulting sum is then stored in memory location 824.

At stage 910, a determination is made as to whether the value stored in memory location 827 or 826 has changed since the end of the previous accrual period. The value of memory location 826 would be reduced if all or some of the principal amount of the debt instrument shown in stage 1 of FIG. 4 has been amortized or paid by the issuer during the accrual period. Similarly, the value of memory location 827 holding the amount of accrued interest arising from the debt instrument will also decline if some or all of the accrued interest amount is paid by the issuer of the debt instrument. If interest or principal payments were required or scheduled to be paid under the debt instrument during the previous accrual period, no decrease in the respective values of 626 or 627 from their values at the previous accrual period means that the issuer of the debt instrument failed to make the required or scheduled payment.

If the result of the determination at stage 910 is “no,” meaning that there has been no change in the value stored in memory location 827 or 826 from their respective values at the end of the previous accrual period, then at stage 924 the computer process waits for the end of the next accrual period and once again performs the same operation as shown in stage 908 for that accrual period.

On the other hand, if the result of the determination at stage 910 is yes, meaning that there has been a change in the value stored in memory location 827 or 826 from their respective values at the end of the previous accrual period, then another determination is made at stage 912 to determine whether the value of memory location 830 and/or 829 has declined from their respective values at the end of the previous accrual period. The value held in memory location 827 directly corresponds to that of memory location 830 except that the former is denominated in currency A while the latter is denominated in currency B. The amount by which memory location 830 decreased should be equal to the value of the decrease in memory location 827 multiplied by the exchange rate expressed as value of currency B over value of currency A. The same relationship is applicable to the decrease realized in memory location 829 with respect to memory location 826 except that the values in those memory locations pertain to the principal amounts of the depositary receipt and its underlying debt instrument respectively. A decrease in the value stored in memory location 826 without a corresponding decrease in the value stored in memory location 829, or similarly, a decrease in the value stored in memory location 827 without a corresponding decrease in the value of memory location 830 means that there has been a failure by the counterparty (i.e. bank A) in the currency swap as shown by stage 2 in FIG. 4 (i.e. bank in country A) to perform some or all of the contracted exchange of currencies scheduled for that time. This failure to perform might be caused by failure of the counterparty itself (i.e. bank A) to perform or because of regulations imposed by the authorities in country A that make it impossible for the swap contract to be performed. The debt service in currency A with respect to the debt service has been paid in country A but there has been a failure to either (i) convert that amount to currency B and/or (ii) transfer the currency B to country B.

Regardless of the reason for non-performance under the currency swap as determined at stage 912, if the answer at this stage is “no,” meaning that debt service under the depositary receipt has not been received by the holder of the depositary receipt, the process then moves on to stage 914 at which the value of the memory location 831 is reduced following the liquidation of the collateral assets in memory location 831 into currency B. The decrease in the value stored in memory location 831 is due to a liquidation of the collateral assets. The proceeds from this liquidation is used to pay for exchange or purchase of the depositary receipt. Following the decrease of the value stored in memory location 831, at stage 916 the value of the investment instrument owed to the holder of the investment instrument as recorded on the books of the issuer of the investment instrument and stored in memory location 822 is increased by the share of the holder of the investment instrument in the income earned from the financial assets denominated in currency B. Also at 916, the value stored in memory location 822 may be reduced by the share of the holder of the investment instrument in the interest expense in currency A incurred under the debt instrument as shown in stage 1 of FIG. 4 multiplied by the rate of exchange into currency B for that period as contracted for under the currency swap shown as stage 2 in FIG. 4.

At stage 918, the value of memory location 822 representing what is owed to the holder of the investment instrument is reduced as a result of the distribution of some or all of the income which accrued to the holder as processed in stage 916. At stage 920, the share of income distributed to the holder of the investment instrument is added to the value of memory location 820 and the resulting sum is stored in memory location 820. At stage 922, the memory location 825 which stores the amount of cash held by the issuer of the investment instrument is reduced by the amount distributed to the holder of the investment instrument as was discussed in stage 918. Following stage 922, at stage 924, the computer process waits for the next accrual period and recycles through the previous stages starting with stage 908 where accrual of interest for that period is again calculated.

FIG. 10 is an example method for investing in an investment instrument offered by the holder of one or more depositary receipts, according to an embodiment. In particular, FIG. 10 shows how an investor can invest in an investment instrument and benefit by earning in whole or in part income derived from one or more depositary receipts, At stage 1002, an investor invests in an investment instrument issued by bank B. In the embodiment shown in FIG. 10, the issuer of the investment instrument is bank B, although other embodiments may also allow other issuers which may directly or indirectly control bank B, to issue the said investment instrument.

At stage 1004, bank A issues or sells the debt instrument in stage 1 of FIG. 4. As a result of the sale or issuance of the debt instrument, Bank A receives proceeds in currency A. Bank A then enters into a currency swap as shown by Stage 2 in FIG. 4 with the depositary bank. Under the terms of the currency swap, Bank A is able to convert the proceeds received from the sale or issuance of the debt instrument into currency B.

At stage 1006, bank A transfers collateral assets to a third party (meaning not bank B) which may be the depositary bank. The collateral assets, which may be denominated in any currency other than currency A, are either already located outside the territory and jurisdiction of country A, or have to be transferred outside the territory and jurisdiction of country A. The depositary bank then issues the depositary receipts and offers it to one or more residents of country B. At stage 1008, bank B invests in the depositary receipt by purchasing the depositary receipt from the depositary bank.

At stage 1010, bank A pays scheduled debt service under the debt instrument. The debt service is paid in a currency other than currency B. At stage 1012, a determination is made as to whether bank B received any debt service under the depositary receipt. An answer of “no” means that an event has occurred in country A which has prevented the amount of debt service paid in country A to be converted into currency B and/or transferred to country B. If the answer to the determination is “no,” at stage 1014, the third party which holds and controls the collateral assets liquidates some or all of the collateral assets. If the proceeds received following the liquidation of the collateral assets are in a currency other than currency B, the third party then exchanges that currency into currency B. As a result of the use of the collateral to purchase the depositary receipt at its outstanding value, including accrued interest, the holder of the depositary receipt is able to liquidate the principal and/or accrued income from the depositary receipt as if it had received the payment from bank A instead of from the collateral assets. The process then moves on to stage 1016.

On the other hand, if the answer to the determination at stage 1012 is “yes,” meaning that bank B received debt service under the depositary receipt which came from bank A, the process moves directly to stage 1016 at which stage bank B realizes the net income from the depositary receipt (and the principal under the depositary receipt as well if the principal amount was repaid), on its accounting records and receives the funds from this debt service.

At stage 1018, bank B distributes to holder of investment instrument his share of net income from the depositary receipt. The amount distributed by bank B to the holder of the investment instrument may be a share of the income received by bank B at stage 1016 less a ratable portion of bank B's general financing cost which may attributable to the depositary receipt. Besides distributing his share of income in the depositary receipt, bank B may also distribute to the holder of the investment instrument other income earned which is unrelated to the depositary receipts.

At stage 1020, the holder of investment instrument issued by bank B receives his share of income from the depositary receipt as distributed to him at stage 1018. After this stage, the holder of the investment instrument is free to spend or invest that share of income as he sees fit.

FIG. 11 is an example method for investing in an investment instrument offered by an issuer of a synthetically denominated debt instrument, according to an embodiment. In particular, FIG. 11 shows how an investor can invest in an investment instrument and benefit by earning in whole or in part income derived from financial assets denominated in currency B that are financed by the synthetically denominated debt instrument as shown in stage 3 of IG. 4 and package into depositary receipt. At stage 1102, an investor invests in an investment instrument issued by bank A. In the embodiment shown in FIG. 11, the issuer of the investment instrument is bank A, although other embodiments may also allow other issuers which may directly or indirectly control bank A to issue the said investment instrument.

At stage 1104, bank A issues or sells the debt instrument in stage 1 of FIG. 4. As a result of the sale or issuance of the debt instrument, bank A receives proceeds in currency A. Bank A then enters into a currency swap as shown by stage 2 in FIG. 4. Under the terms of the currency swap, bank A is able to convert the proceeds received from the sale or issuance of the debt instrument into currency B.

At stage 1106, bank A then takes the currency B proceeds which it received at stage 1104 and invests said proceeds into assets located in country B and denominated in currency B. At stage 1108, bank A transfers collateral assets to another party (meaning not bank A) which may also be the depositary bank. The collateral assets, which may be denominated in any currency other than currency A, are either have to be transferred outside the territory and jurisdiction of country A or are already located outside the territory and jurisdiction of country A. The depositary bank then issues the depositary receipts and offers it to one or more residents of country B. At stage 1110, bank B invests in the depositary receipt by purchasing the depositary receipt from the depositary bank.

At stage 1112, Bank A pays scheduled debt service under the debt instrument. The debt service is paid in a currency other than currency B. At stage 1114, a determination is made as to whether Bank B received any debt service under the depositary receipt. An answer of “no” means that an event has occurred in country A that has prevented the performance of the currency swap shown as stage 2 in FIG. 4. This event has prevented the debt service under the debt instrument in country A from being converted to currency B and/or prevented the amount from being transferred to country B. If the answer to the determination at stage 1116 is “no,” the party which holds the collateral assets liquidates some or all of the collateral assets. If the proceeds received following the liquidation of the collateral assets are in a currency other than currency B, that party then exchanges that currency into currency B. The process then moves on to stage 1118.

On the other hand, if the answer to the determination at stage 1114 is “yes,” meaning that bank B received debt service under the depositary receipt, the process moves directly to stage 1118 at which stage bank B realizes the net income from the depositary receipt (and the principal under the depositary receipt as well if the principal amount was repaid), on its accounting records and receives the funds from this debt service. As shown in FIG. 11, stage 1118 is reached from either stage 1116 or stage 1114 the difference being that in the former case the funds due under the depositary receipt came from liquidation of the collateral assets and not from bank A while in the latter case, the funds due under the depositary receipt came from bank A.

At stage 1120, bank A receives the income from assets denominated in currency B which are located in country B and which are financed by the synthetically denominated debt instrument in currency B. At stage 1122, Bank A distributes to holder of investment instrument his share of net income from the assets denominated in currency B. The amount distributed by Bank A to the holder of the investment instrument may be a share of the income received by Bank A from the assets denominated in currency B at stage 1120 less a ratable portion of Bank A's cost of financing through issuance of the synthetically denominated debt instrument. Besides distributing his share of income in the income and expense with respect to assets and liabilities denominated in currency B, bank A may also distribute to the holder of the investment instrument other income earned from assets denominated in currency B.

At stage 1124, the holder of investment instrument issued by Bank A receives his share of income as distributed to him at stage 1122. After this stage, the holder of the investment instrument is free to spend or invest that share of income as he sees fit.

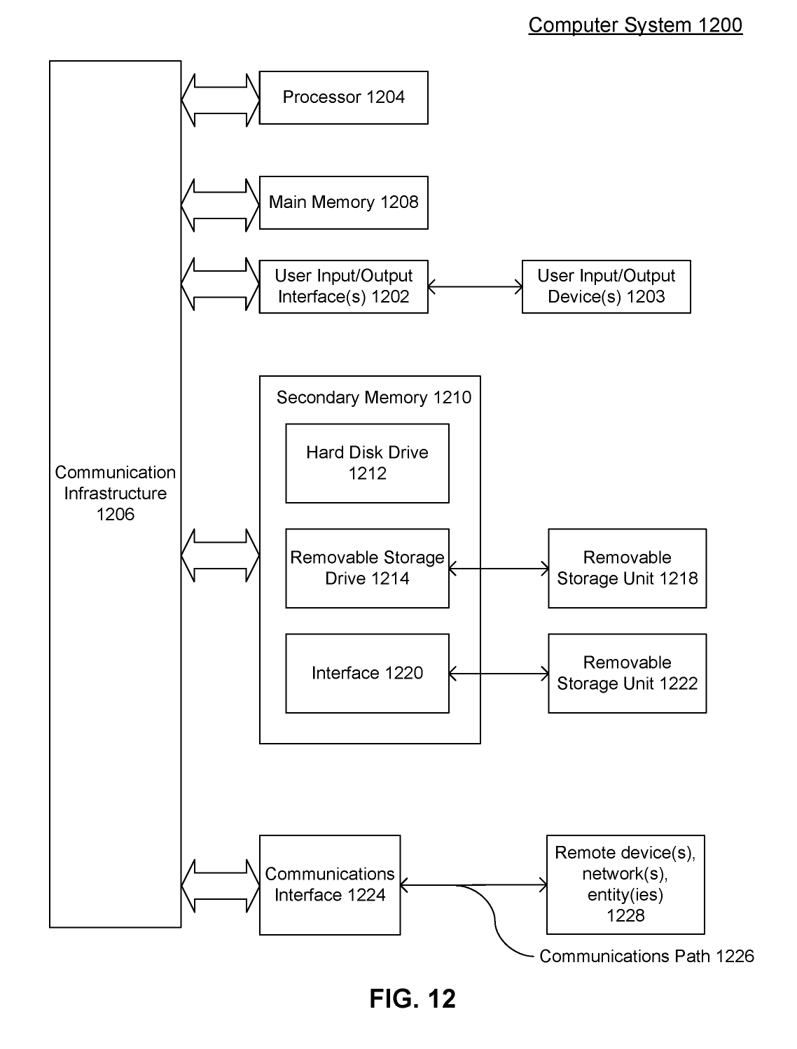

FIG. 12 is an example computing system useful for implementing various embodiments. Various embodiments can be implemented, for example, using one or more well-known computer systems, such as computer system 1200. Computer system 1200 can be any well-known computer capable of performing the functions described herein, such as computers available from international Business Machines, Apple, Sun, HP, Dell, Sony, Toshiba, etc.

Computer system 1200 includes one or more processors (also called central processing units, or CPUs), such as a processor 1204. Processor 1204 may be connected to a communication infrastructure or bus 1206.

One or more processors 1204 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1200 also includes user input/output device(s) 1203, such as monitors, keyboards, pointing devices, etc., which communicate with communication infrastructure 1206 through user input/output interface(s) 1202.

Computer system 1200 also includes a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 includes a computer usable or readable storage device having stored thereon computer software (control logic) and/or data. Removable storage unit 1218 may be a floppy disk, magnetic tape, compact disk, DVD, optical storage disk, and/or any other computer data storage device. Removable storage drive 1214 reads from and/or writes to removable storage unit 1218 in a well-known manner.

According to an exemplary embodiment, secondary memory 1210 may include other means, instrumentalities, or other approaches for allowing computer programs and/or other instructions and/or data to be accessed by computer system 1200. Such means, instrumentalities, or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 enables computer system 1200 to communicate and interact with any combination of remote devices, remote networks, remote entities, etc. (individually and collectively referenced by reference number 1228). For example, communication interface 1224 may allow computer system 1200 to communicate with remote devices 1228 over communications path 1226, which may be wired and/or wireless, and which may include any combination of LANs, WANs, the Internet, etc. Control logic and/or data may be transmitted to and from computer system 1200 via communication path 1226.

In an embodiment, a tangible apparatus or article of manufacture comprising a tangible computer useable or readable medium having control logic (software) stored thereon is also referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 12. In particular, embodiments may operate with software, hardware, and/or operating system implementations other than those described herein.

Embodiments disclosed herein have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the inventions that others can, by applying knowledge within the skill of the art, readily modify and/or adapt for various applications such specific embodiments, without undue experimentation, without departing from the general concept of the present inventions. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present inventions should not be limited by any of the above-described embodiments, but should be defined only in accordance with the following claims and their equivalents

What is claimed is:

1. A method for collateralizing and investing in synthetically denominated debt instruments, comprising:
issuing a debt security in a first entity that is denominated in a first currency, wherein the first currency is a local currency of the first entity;
issuing a currency swap on the debt security specifying exchange of cash flows in the first currency for cash flows in a second currency, wherein the second currency is a local currency of a second entity;
creating a synthetically denominated debt instrument, wherein the synthetically denominated debt instrument is a combination of the debt security and the currency swap;
delivering the synthetically denominated debt instrument to a depositary bank in the second entity, wherein a depositary receipt representing the synthetically denominated debt instrument is issued in the second entity by the depositary bank to an investor in the synthetically denominated debt instrument;
posting collateral assets in the second entity denominated in the second currency; and
attaching the collateral assets to the depositary receipt such that the depositary receipt is exchangeable for the collateral assets in the event of non-payment of promised cash flows by the issuer of the debt security.

2. The method of claim 1, wherein the collateral assets are held in a collateral account in the second entity by the depositary bank.

3. The method of claim 2, further comprising:
detecting whether debt service was received by the investor in the depositary receipt for a particular time period;
automatically initiating communication with the depositary bank to liquidate all or a portion of the collateral assets upon detecting that debt service was not received; and
delivering the liquidated assets to the investor in the depositary receipt.

4. The method of claim 1, further comprising investing proceeds received from the investor in assets of a borrowing party in the second entity, wherein the proceeds are denominated in the second currency.

5. The method of claim 4, further comprising issuing an investment instrument that entitles a holder of the investment instrument to a share of net income from investment in the assets of the borrowing party.

6. The method of claim 1, wherein the investor is a bank, company, or other institution.

7. The method of claim 6, wherein the investor issues an investment instrument that entitles a holder of the investment instrument to a share of net income from the depositary receipt.

8. A system for collateralizing and investing in synthetically denominated debt instruments comprising:
one or more computing devices;
a securities manager, implemented on the one or more computing devices, configured to:
issue a debt security in a first entity that is denominated in a first currency, wherein the first currency is a local currency of the first entity;
issue a currency swap on the debt security specifying exchange of cash flows in the first currency for cash flows in a second currency, wherein the second currency is a local currency of a second entity; and
create a synthetically denominated debt instrument, wherein the synthetically denominated debt instrument is a combination of the debt security and the currency swap;
a delivery manager, implemented on the one or more computing devices, configured to deliver the synthetically denominated debt instrument to a depositary bank in the second entity, wherein a depositary receipt representing the synthetically denominated debt instrument is issued in the second entity by the depositary bank to an investor in the synthetically denominated debt instrument; and
a collateralization manager, implemented on the one or more computing devices, configured to:
post collateral assets in the second entity denominated in the second currency; and
attach the collateral assets to the depositary receipt such that the depositary receipt is exchangeable for the collateral assets in the event of non-payment of promised cash flows by the issuer of the debt security.

9. The system of claim 8, wherein the collateral assets are held in a collateral account n the second entity by the depositary bank.

10. The system of claim 9, wherein the collateralization manager is further configured to:
detect whether debt service was received by the investor in the depositary receipt for a particular time period;
automatically initiate communication with the depositary bank to liquidate all or a portion of the collateral assets upon detecting that debt service was not received; and
deliver the liquidated assets to the investor in the depositary receipt.

11. The system of claim 8, further comprising:
a lending manager, implemented on the one or more computing devices, configured to invest proceeds received from the investor in assets of a borrowing party in the second entity, wherein the proceeds are denominated in the second currency.

12. The system of claim 11, wherein the securities manager is further configured to issue an investment instrument that entitles a holder of the investment instrument to a share of net income from investment in the assets of the borrowing party.

13. The system of claim 8, wherein the investor is a bank, company, or other institution.

14. The system of claim 13, wherein the investor issues an investment instrument that entitles a holder of the investment instrument to a share of net income from the depositary receipt.

15. A non-transitory computer-readable storage device having instructions stored thereon that, when executed by at least one computing device, causes the at least one computing device to perform operations carrying out the method of any of claims 1-7.

16. A system for collateralizing and investing in synthetically denominated debt instruments, comprising:
means for issuing a debt security in a first entity that is denominated in a first currency, wherein the first currency is a local currency of the first entity;
means for issuing a currency swap on the debt security specifying exchange of cash flows in the first currency for cash flows in a second currency, wherein the second currency is a local currency of a second entity;
means for creating a synthetically denominated debt instrument, wherein the synthetically denominated debt instrument is a combination of the debt security and the currency swap;
means for delivering the synthetically denominated debt instrument to a depositary bank in the second entity_{;} wherein a depositary receipt representing the synthetically denominated debt instrument is issued in the second entity by the depositary bank to an investor in the synthetically denominated debt instrument;
means for posting collateral assets in the second entity denominated in the second currency; and
means for attaching the collateral assets to the depositary receipt such that the depositary receipt is exchangeable for the collateral assets in the event of non-payment of promised cash flows by the issuer of the debt security.

17. The system of claim 16, wherein the collateral assets are held in a collateral account in the second entity by the depositary bank.

18. The system of claim 17, further comprising:
means for detecting whether debt service was received by the investor in the depositary receipt for a particular time period;
means for automatically initiating communication with the depositary bank to liquidate all or a portion of the collateral assets upon detecting that debt service was not received; and
means for delivering the liquidated assets to the investor in the depositary receipt.

19. The system of claim 16, further comprising means for investing proceeds received from the investor in assets of a borrowing party in the second entity, wherein the proceeds are denominated in the second currency.

20. The system of claim 19, further comprising means for issuing an investment instrument that entitles a holder of the investment instrument to a share of net income from investment in the assets of the borrowing party.

21. The system of claim 16, wherein the investor is a bank, company, or other institution.

22. The system of claim 21, wherein the investor issues an investment instrument that entitles a holder of the investment instrument to a share of net income from the depositary receipt.

23. A method for investing in synthetically denominated debt instruments, comprising:
purchasing a depositary receipt representing a synthetically denominated debt instrument, wherein the synthetically denominated debt instrument is a combination of a debt security and a currency swap issued by a common issuer,
wherein the depositary receipt is exchangeable for collateral assets attached to the depositary receipt in the event of non-payment of promised cash flows by the issuer,
wherein the debt security is denominated in a first currency local to a first entity and the currency swap specifies exchange of cash flows in the first currency for cash flows in a second currency local to a second entity,
wherein the depositary receipt is issued by a depositary bank in the second entity, and
wherein the collateral assets are denominated in the second currency and held in a. collateral account in the second entity.

24. A method for investing in synthetically denominated debt instruments, comprising
purchasing, by an investor, an investment instrument issued by a backing party, wherein the backing party holds a depositary receipt representing a synthetically denominated debt instrument that is a combination of a debt security and a currency swap issued by a common issuer,
wherein the investment instrument entitles the investor to a share of net income from the depositary receipt,
wherein the depositary receipt is exchangeable for collateral assets attached to the depositary receipt in the event of non-payment of promised cash flows by the issuer,
wherein the debt security is denominated in a first currency local to a first entity and the currency swap specifies exchange of cash flows in the first currency for cash flows in a second currency local to a second entity,
wherein the depositary receipt is issued by a depositary bank in the second entity,
wherein the collateral assets are denominated in the second currency and held in a collateral account in the second entity, and
wherein the investor resides in an entity different from the backing party.
